(19) United States
(12) Patent Application Publication
(10) Pub. No.: US 2026/0009926 A1
(43) Pub. Date: Jan. 8, 2026

(54) DOWNHOLE INSTRUMENT ACQUISITION AND TELEMETRY SYSTEM

(71) Applicant: SCHLUMBERGER TECHNOLOGY CORPORATION, Sugar Land, TX (US)

(72) Inventors: Bo YU, Sugar Land, TX (US); Nick HEATON, Cambridge (GB); Albina MUTINA, Clamart (FR); Xiaohong WU, Sugar Land, TX (US)

(21) Appl. No.: 19/117,977

(22) PCT Filed: Oct. 4, 2023
(86) PCT No.: PCT/US2023/034445

§ 371 Date: Apr. 3, 2025

(30) Foreign Application Priority Data
Oct. 7, 2022 (EP) 22306510.3

(51) Int. Cl. G01V 3/32; E21B 47/12

(52) U.S. Cl. CPC G01V 3/32; E21B 47/12

(57) ABSTRACT

A method may include acquiring NMR data using a NMR unit disposed in a borehole in a formation, where the NMR data represent characteristics of the formation. The method may also include compressing the NMR data using projection followed by adaptive quantization to generate multiple, quantized data structures, where the adaptive quantization selects a gain value from a plurality of gain values. The method may further include transmitting the multiple, quantized data structures using borehole telemetry, where the multiple, quantized data structures include an indicator for the selected gain value.

### CROSS REFERENCE PARAGRAPH

This application claims the benefit of European Patent Application No. 22306510.3, entitled “DOWNHOLE INSTRUMENT ACQUISITION AND TELEMETRY SYSTEM,” filed Oct. 7, 2022, the disclosure of which is hereby incorporated herein by reference.

### BACKGROUND

Various types of operations can be performed using a system that includes memory and telemetry circuitry where the memory may be limited and/or where the telemetry may be limited.

### SUMMARY

A method can include acquiring NMR data using a NMR unit disposed in a borehole in a formation, where the NMR data represent characteristics of the formation; compressing the NMR data using projection followed by adaptive quantization to generate multiple, quantized data structures, where the adaptive quantization selects a gain value from a plurality of gain values; and transmitting the multiple, quantized data structures using borehole telemetry, where the multiple, quantized data structures include an indicator for the selected gain value.

A system can include a processor; memory accessible to the processor; processor-executable instructions stored in the memory and executable by the processor to instruct the system to: acquire NMR data using a NMR unit disposed in a borehole in a formation, where the NMR data represent characteristics of the formation; compress the NMR data using projection followed by adaptive quantization to generate multiple, quantized data structures, wherein the adaptive quantization selects a gain value from a plurality of gain values; and transmit the multiple, quantized data structures using borehole telemetry, wherein the multiple, quantized data structures include an indicator for the selected gain value.

One or more computer-readable storage media can include processor-executable instructions executable to instruct a processor to: acquire NMR data using a NMR unit disposed in a borehole in a formation, where the NMR data represent characteristics of the formation; compress the NMR data using projection followed by adaptive quantization to generate multiple, quantized data structures, where the adaptive quantization selects a gain value from a plurality of gain values; and transmit the multiple, quantized data structures using borehole telemetry, wherein the multiple, quantized data structures include an indicator for the selected gain value.

Various other apparatuses, systems, methods, etc., are also disclosed. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates examples of equipment in a geologic environment;

FIG. 2 illustrates an example of a system and examples of types of holes;

FIG. 3 illustrates an example of a system;

FIG. 4 illustrates an example of a method and an example of a system;

FIG. 5 illustrates an example of a method and an example of a tool;

FIG. 6 illustrates an example of a system;

FIG. 7 illustrates an example of a microprocessor and an example of circuitry;

FIG. 8 illustrates an example of a graphical user interface;

FIG. 9 illustrates an example of a graph;

FIG. 10 illustrates examples of graphs;

FIG. 11 illustrates examples of graphs;

FIG. 12 illustrates examples of graphs;

FIG. 13 illustrates an example of a graph;

FIG. 14 illustrates an example of a graph;

FIG. 15 illustrates an example of a graph;

FIG. 16 illustrates examples of computing and networking equipment; and

FIG. 17 illustrates example components of a system and a networked system.

### DETAILED DESCRIPTION

The following description includes embodiments of the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, various types of operations can be performed using a system that includes memory and telemetry circuitry where the memory may be limited and/or where the telemetry may be limited. Various operations can be performed in a field. For example, consider exploration as an initial phase in petroleum operations that includes generation of a prospect or play or both, and drilling of an exploration well or borehole. Appraisal, development and production phases may follow successful exploration.

A borehole may be referred to as a wellbore and can include an openhole portion or an uncased portion and/or may include a cased portion. A borehole may be defined by a bore wall that is composed of rock that bounds the borehole. As to a well or a borehole, whether for one or more of exploration, sensing, production, injection or other operation(s), it can be planned. Such a process may be referred to generally as well planning, a process by which a path can be mapped in a geologic environment. Such a path may be referred to as a trajectory, which can include coordinates in a three-dimensional coordinate system where a measure along the trajectory may be a measured depth (MD), a total vertical depth (TVD) or another type of measure. During drilling, wireline investigations, etc., equipment may be moved into and/or out of a well or borehole. Such operations can occur over time and may differ with respect to time (e.g., due to changed conditions). As an example, drilling can include using one or more logging tools that can perform one or more logging operations while drilling or otherwise with a drillstring (e.g., while stationary, while tripping in, tripping out, etc.). As an example, a wireline operation can include using one or more logging tools that can perform one or more logging operations. A planning process may call for performing various operations, which may be serial, parallel, serial and parallel, etc.

As an example, drilling or one or more other operations may occur responsive to measurements. For example, a logging while drilling operation may acquire measurements and adjust drilling based at least in part on such measurements. As an example, a logging operation can include moving a logging tool, stopping a logging tool, or otherwise controlling a logging tool based at least in part on measurements acquired by the logging tool or, for example, another logging tool (e.g., sensor unit, etc.).

As an example, a nuclear magnetic resonance (NMR) unit can be utilized to determine properties of objects, substances or objects and substances. In various operations, a downhole tool can include one or more NMR units that can acquire NMR measurements. Such measurements may provide for characterization of one or more objects, one or more substances, etc. Such measurements may be acquired using wireline technology, drilling technology (e.g., logging while drilling, etc.), or other downhole technology. As an example, NMR technology can be utilized in a geologic environment to characterize the geologic environment (e.g., formation characterization, fluid characterization, etc.).

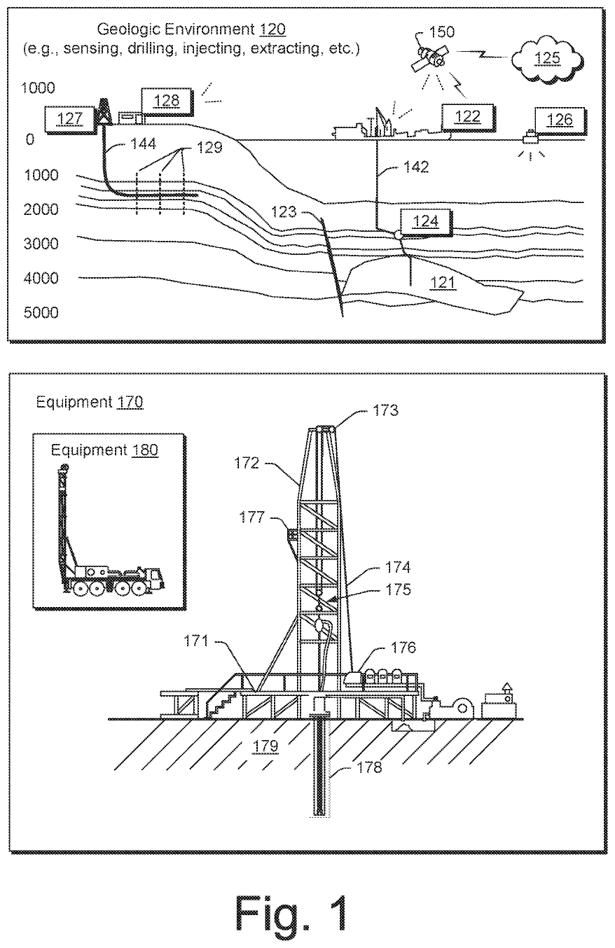

FIG. 1 shows an example of a geologic environment 120. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with a variety of sensors, detectors, actuators, etc. For example, equipment 122 may include communication circuitry to receive and/or to transmit information with respect to one or more networks 125. Such information may include information associated with downhole equipment 124, which may be equipment to acquire information, to assist with resource recovery, etc. For example, the downhole equipment 124 can be disposed in a bore 142 that is formed by a borewall of one or more types of rock. Other equipment 126 may be located remote from a well site and include sensing, detecting, emitting or other circuitry. Such equipment may include storage and communication circuitry to store and to communicate data, instructions, etc. As an example, one or more pieces of equipment may provide for measurement, collection, communication, storage, analysis, etc. of data (e.g., for one or more produced resources, etc.). As an example, one or more satellites may be provided for purposes of communications, data acquisition, geolocation, etc. For example, FIG. 1 shows a satellite 150 in communication with the network 125 that may be configured for communications, noting that the satellite 150 may additionally or alternatively include circuitry for imagery (e.g., spatial, spectral, temporal, radiometric, etc.).

FIG. 1 also shows the geologic environment 120 as optionally including equipment 127 and 128 associated with a well 144 that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, NMR logging, assessment of one or more fractures, injection, production, etc. As an example, the equipment 127 and/or 128 may provide for measurement, collection, communication, storage, analysis, etc. of data such as, for example, formation data, fluid data, production data (e.g., for one or more produced resources), etc. As an example, one or more satellites such as the satellite 150 may be provided for purposes of communications, data acquisition, etc.

FIG. 1 also shows an example of equipment 170 and an example of equipment 180. Such equipment, which may be systems of components, may be suitable for use in the geologic environment 120. While the equipment 170 and 180 are illustrated as land-based, various components may be suitable for use in an offshore system. As shown in FIG. 1, the equipment 180 can be mobile as carried by a vehicle; noting that the equipment 170 can be assembled, disassembled, transported and re-assembled, etc.

The equipment 170 includes a platform 171, a derrick 172, a crown block 173, a line 174, a traveling block assembly 175, drawworks 176 and a landing 177 (e.g., a monkeyboard). As an example, the line 174 may be controlled at least in part via the drawworks 176 such that the traveling block assembly 175 travels in a vertical direction with respect to the platform 171. For example, by drawing the line 174 in, the drawworks 176 may cause the line 174 to run through the crown block 173 and lift the traveling block assembly 175 skyward away from the platform 171; whereas, by allowing the line 174 out, the drawworks 176 may cause the line 174 to run through the crown block 173 and lower the traveling block assembly 175 toward the platform 171. Where the traveling block assembly 175 carries pipe (e.g., casing, etc.), tracking of movement of the traveling block 175 may provide an indication as to how much pipe has been deployed. As shown, movement of the traveling block assembly 175 can provide for movement of equipment into and out of a bore 178 in a formation 179.

A derrick can be a structure used to support a crown block and a traveling block operatively coupled to the crown block at least in part via line. A derrick may be pyramidal in shape and offer a suitable strength-to-weight ratio. A derrick may be movable as a unit or in a piece by piece manner (e.g., to be assembled and disassembled).

As an example, drawworks may include a spool, brakes, a power source and assorted auxiliary devices. Drawworks may controllably reel out and reel in line. Line may be reeled over a crown block and coupled to a traveling block to gain mechanical advantage in a “block and tackle” or “pulley” fashion. Reeling out and in of line can cause a traveling block (e.g., and whatever may be hanging underneath it), to be lowered into or raised out of a bore. Reeling out of line may be powered by gravity and reeling in by a motor, an engine, etc. (e.g., an electric motor, a diesel engine, etc.).

As an example, a crown block can include a set of pulleys (e.g., sheaves) that can be located at or near a top of a derrick or a mast, over which line is threaded. A traveling block can include a set of sheaves that can be moved up and down in a derrick or a mast via line threaded in the set of sheaves of the traveling block and in the set of sheaves of a crown block. A crown block, a traveling block and a line can form a pulley system of a derrick or a mast, which may enable handling of heavy loads (e.g., drillstring, pipe, casing, liners, etc.) to be lifted out of or lowered into a bore. As an example, line may be about a centimeter to about five centimeters in diameter as, for example, steel cable. Through use of a set of sheaves, such line may carry loads heavier than the line could support as a single strand.

As an example, a derrick person may be a rig crew member that works on a platform attached to a derrick or a mast. A derrick can include a landing on which a derrick person may stand. As an example, such a landing may be about 10 meters or more above a rig floor. In an operation referred to as trip out of the hole (TOH or pull out of hole (POOH)), a derrick person may wear a safety harness that enables leaning out from the work landing (e.g., monkeyboard) to reach pipe in located at or near the center of a derrick or a mast and to throw a line around the pipe and pull it back into its storage location (e.g., fingerboards), for example, until it a time at which it may be desirable to run the pipe back into the bore. As an example, a rig may include automated pipe-handling equipment such that the derrick person controls the machinery rather than physically handling the pipe.

As an example, a trip may refer to the act of pulling equipment from a bore (POOH) and/or placing equipment in a bore (e.g., run in hole (RIH)). As an example, equipment may include a drillstring that can be pulled out of the hole and/or place or replaced in the hole. As an example, a pipe trip may be performed where a drill bit has dulled or has otherwise ceased to drill efficiently and is to be replaced. As an example, a trip may be performed when changing section diameter, for example, upon finishing a larger bore diameter section changing equipment to drill a smaller bore diameter section.

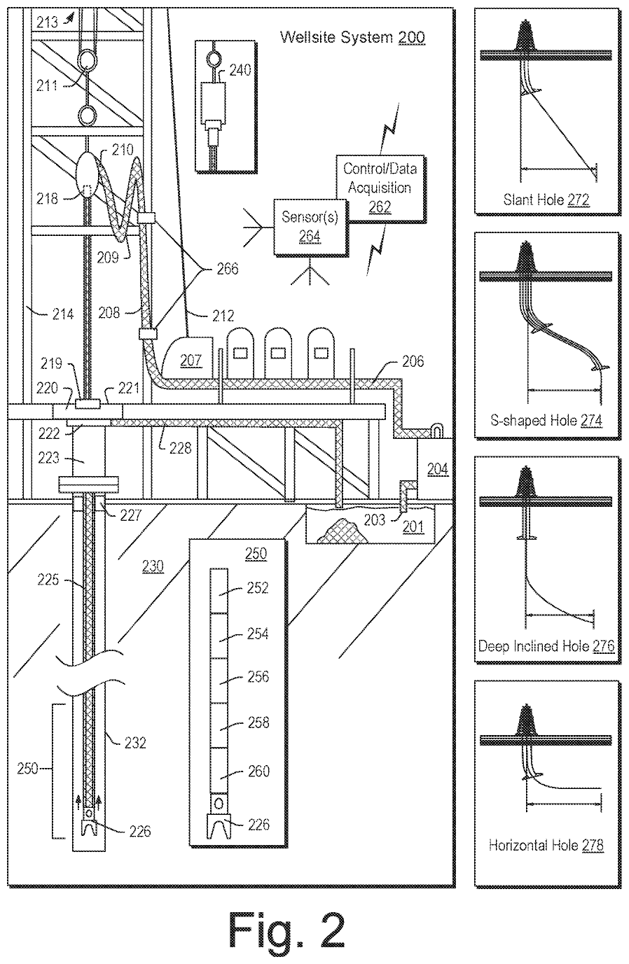

FIG. 2 shows an example of a wellsite system 200 (e.g., at a wellsite that may be onshore or offshore). As shown, the wellsite system 200 can include a mud tank 201 for holding mud and other material (e.g., where mud can be a drilling fluid that may help to transport cuttings, etc.), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212 (see, e.g., the crown block 173 of FIG. 1), a derrick 214 (see, e.g., the derrick 172 of FIG. 1), a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use directional drilling or one or more other types of drilling.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 can provide for operation of the drillstring 225 and other operations. As shown, the wellsite system 200 includes the platform 215 and the derrick 214 positioned over the borehole 232. As mentioned, the wellsite system 200 can include the rotary table 220 where the drillstring 225 passes through an opening in the rotary table 220.

As shown in the example of FIG. 2, the wellsite system 200 can include the kelly 218 and associated components, etc., or a top drive 240 and associated components. As to a kelly example, the kelly 218 may be a square or hexagonal metal/alloy bar with a hole drilled therein that serves as a mud flow path. The kelly 218 can be used to transmit rotary motion from the rotary table 220 via the kelly drive bushing 219 to the drillstring 225, while allowing the drillstring 225 to be lowered or raised during rotation. The kelly 218 can pass through the kelly drive bushing 219, which can be driven by the rotary table 220. As an example, the rotary table 220 can include a master bushing that operatively couples to the kelly drive bushing 219 such that rotation of the rotary table 220 can turn the kelly drive bushing 219 and hence the kelly 218. The kelly drive bushing 219 can include an inside profile matching an outside profile (e.g., square, hexagonal, etc.) of the kelly 218; however, with slightly larger dimensions so that the kelly 218 can freely move up and down inside the kelly drive bushing 219.

As to a top drive example, the top drive 240 can provide functions performed by a kelly and a rotary table. The top drive 240 can turn the drillstring 225. As an example, the top drive 240 can include one or more motors (e.g., electric and/or hydraulic) connected with appropriate gearing to a short section of pipe called a quill, that in turn may be screwed into a saver sub or the drillstring 225 itself. The top drive 240 can be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 can hold mud, which can be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via a the lines 206, 208 and 209 to a port of the kelly 218 or, for example, to a port of the top drive 240. The mud can then flow via a passage (e.g., or passages) in the drillstring 225 and out of ports located on the drill bit 226 (see, e.g., a directional arrow). As the mud exits the drillstring 225 via ports in the drill bit 226, it can then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud can be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more components of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measurement-while-drilling (MWD) module 256, an optional module 258, a rotary-steerable system (RSS) and/or motor 260, and the drill bit 226. Such components or modules may be referred to as tools where a drillstring can include a plurality of tools.

As to a RSS, it involves technology utilized for direction drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit during directional drilling. A PDM operates as drilling fluid is pumped through it where the PDM converts hydraulic power of the drilling fluid into mechanical power to cause the bit to rotate. A PDM can operate in a so-called sliding mode, when the drillstring is not rotated from the surface.

A RSS can drill directionally where there is continuous rotation from surface equipment, which can alleviate the sliding of a steerable motor (e.g., a PDM). A RSS may be deployed when drilling directionally (e.g., deviated, horizontal, or extended-reach wells). A RSS can aim to minimize interaction with a borehole wall, which can help to preserve borehole quality. A RSS can aim to exert a relatively consistent side force akin to stabilizers that rotate with the drillstring or orient the bit in the desired direction while continuously rotating at the same number of rotations per minute as the drillstring.

The LWD module 254 may be housed in a suitable type of drill collar and can contain one or a plurality of selected types of logging tools (e.g., NMR unit or units, etc.). It will also be understood that more than one LWD and/or MWD module can be employed, for example, as represented at by the module 256 of the drillstring assembly 250. Where the position of an LWD module is mentioned, as an example, it may refer to a module at the position of the LWD module 254, the module 256, etc. An LWD module can include capabilities for measuring, processing, and storing information, as well as for communicating with the surface equipment. In the illustrated example, the LWD module 254 may include a seismic measuring device, an NMR measuring device, etc.

The MWD module 256 may be housed in a suitable type of drill collar and can contain one or more devices for measuring characteristics of the drillstring 225 and the drill bit 226. As an example, the MWD tool 254 may include equipment for generating electrical power, for example, to power various components of the drillstring 225. As an example, the MWD tool 254 may include the telemetry equipment 252, for example, where the turbine impeller can generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

As an example, one or more NMR measuring devices (e.g., NMR units, etc.) may be included in a drillstring (e.g., a BHA, etc.) where, for example, measurements may support one or more of geosteering, geostopping, trajectory optimization, etc. As an example, motion characterization data can be utilized for control of NMR measurements (e.g., acquisition, processing, quality assessment, etc.).

FIG. 2 also shows some examples of types of holes that may be drilled. For example, consider a slant hole 272, an S-shaped hole 274, a deep inclined hole 276 and a horizontal hole 278.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees. As an example, a trajectory and/or a drillstring may be characterized in part by a dogleg severity (DLS), which can be a two-dimensional parameter specified in degrees per 30 meters (e.g., or degrees per 100 feet).

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform method such as geosteering. As mentioned, a steerable system can be or include an RSS. As an example, a steerable system can include a PDM or of a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; a combinable magnetic resonance (CMR) tool for measuring properties (e.g., relaxation properties, etc.); one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 can include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 can be provided for tracking pipe, tracking movement of at least a portion of a drillstring, etc.

As an example, the system 200 can include one or more sensors 266 that can sense and/or transmit signals to a fluid conduit such as a drilling fluid conduit (e.g., a drilling mud conduit). For example, in the system 200, the one or more sensors 266 can be operatively coupled to portions of the standpipe 208 through which mud flows. As an example, a downhole tool can generate pulses that can travel through the mud and be sensed by one or more of the one or more sensors 266 (e.g., consider mud-pulse telemetry). In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 can include a transmitter that can generate signals that can be transmitted downhole via mud (e.g., drilling fluid) as a transmission medium. As an example, data acquired by an NMR unit may be processed in a manner that can reduce data load, which can facilitate transmission. For example, consider downhole processing of NMR measurements to reduce a total number of bits to be transmitted (e.g., consider downhole data compression, downhole data analysis, etc.).

Analysis of formation information acquired by one or more tools may reveal features such as, for example, vugs, dissolution planes (e.g., dissolution along bedding planes), stress-related features, dip events, etc. As an example, a tool may acquire information that may help to characterize a reservoir, optionally a fractured reservoir where fractures may be natural and/or artificial (e.g., hydraulic fractures). A reservoir can be a porous formation where fluid can be within various pores of the porous formation and amenable to movement (e.g., to produce fluid from the reservoir). As an example, information acquired by a tool or tools may be analyzed using a framework such as the TECHLOG framework (Schlumberger Limited, Houston, Texas). As an example, the TECHLOG framework can be interoperable with one or more other frameworks such as, for example, the PETREL framework (Schlumberger Limited, Houston, Texas). As an example, a computational environment such as, for example, the DELFI environment (Schlumberger Limited, Houston, Texas) may be utilized, which can provide for utilization of the PETRL framework and other frameworks, optionally in interrelated manners.

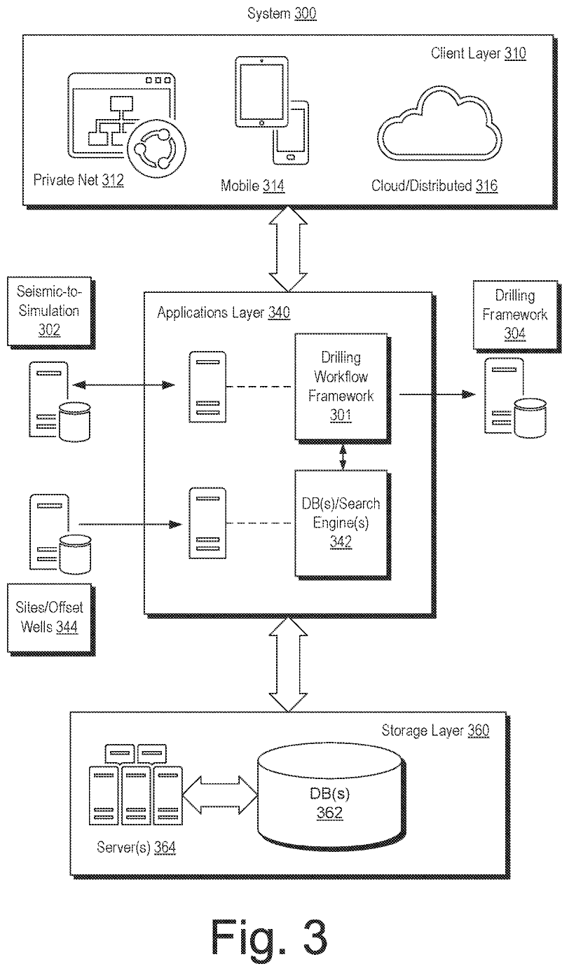

FIG. 3 shows an example of a system 300 that includes a drilling workflow framework 301, a seismic-to-simulation framework 302, a drilling framework 304, a client layer 310, an applications layer 340 and a storage layer 360. As shown the client layer 310 can be in communication with the applications layer 340 and the applications layer 340 can be in communication with the storage layer 360. In such an example, a computational framework may be provided for handling of logging measurements and/or data derived from logging measurements. For example, logging information may be provided to the seismic-to-simulation framework 302 and/or to the drilling framework 304. Such information may be utilized for model building (e.g., constructing a multidimensional model of a geologic environment), generating a trajectory for a well (e.g., or an extension thereof), generating a stimulation plan (e.g., fracturing, chemical treatment, etc.), controlling one or more drilling operations, etc.

In the example of FIG. 3, the client layer 310 can include features that allow for access and interactions via one or more private networks 312, one or more mobile platforms and/or mobile networks 314 and via the “cloud” 316, which may be considered to include distributed equipment that forms a network such as a network of networks.

In the example of FIG. 3, the applications layer 340 includes the drilling workflow framework 301. The applications layer 340 also includes a database management component 342 that includes one or more search engine features (e.g., sets of executable instructions to perform various actions, etc.). As shown, the applications layer can receive data from one or more databases 344 for various sites, which can include offset well sites.

In the example of FIG. 3, the applications layer 340 can provide for communicating with one or more resources such as, for example, the seismic-to-simulation framework 302, the drilling framework 304 and/or the one or more databases 344 for one or more sites, which may be or include one or more offset wellsites. As an example, the applications layer 340 may be implemented for a particular wellsite where information can be processed as part of a workflow for operations such as, for example, operations performed, being performed and/or to be performed at the particular wellsite. As an example, an operation may involve directional drilling, for example, via geosteering. As an example, an operation may involve logging via one or more downhole tools.

In the example of FIG. 3, the storage layer 360 can include various types of data, information, etc., which may be stored in one or more databases 362. As an example, one or more servers 364 may provide for management, access, etc., to data, information, etc., stored in the one or more databases 362. As an example, the database management component 342 may provide for searching as to data, information, etc., stored in the one or more databases 362.

As an example, the system 300 of FIG. 3 may be implemented to perform one or more portions of one or more workflows associated with the system 200 of FIG. 2. As an example, the drilling workflow framework 301 may interact with a technical data framework (e.g., a logging data framework, etc.) and the drilling framework 304 before, during and/or after performance of one or more drilling operations. In such an example, the one or more drilling operations may be performed in a geologic environment (see, e.g., the geologic environment 120 of FIG. 1) using one or more types of equipment (see, e.g., equipment of FIGS. 1 and 2).

As an example, an architecture utilized in a system such as, for example, the system 300, may include features of the AZURE architecture (Microsoft Corporation, Redmond, Washington). As an example, a cloud portal block can include one or more features of an AZURE portal that can manage, mediate, etc. access to one or more services, data, connections, networks, devices, etc. As an example, the system 300 may include features of the GOOGLE cloud architecture (Google, Mountain View, California) and/or one or more other cloud platforms.

As an example, the system 300 can include a cloud computing platform and infrastructure, for example, for building, deploying, and managing applications and services (e.g., through a network of datacenters, etc.). As an example, such a cloud platform may provide PaaS and IaaS services and support one or more different programming languages, tools and frameworks, etc.

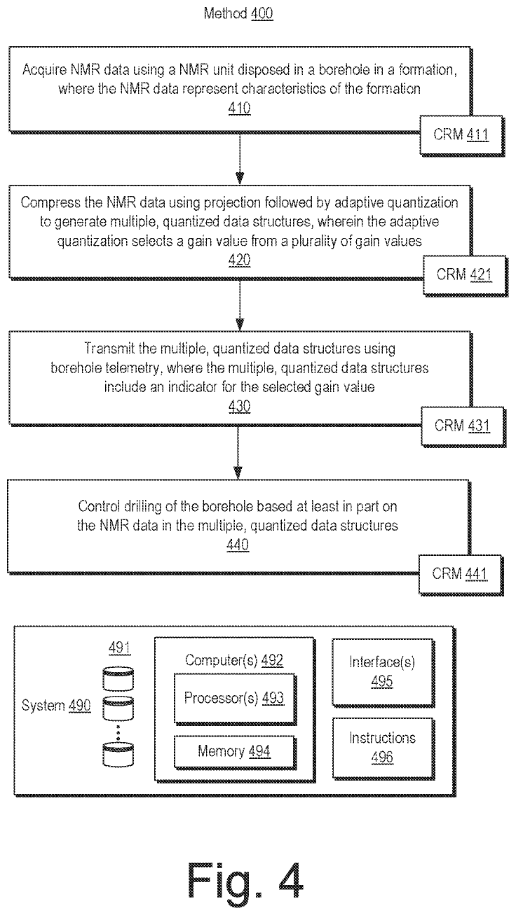

FIG. 4 shows an example of a method 400 that includes an acquisition block 410 for acquiring NMR data using a NMR unit disposed in a borehole in a formation, where the NMR data represent characteristics of the formation; a compression block 420 for compressing the NMR data using projection followed by adaptive quantization to generate multiple, quantized data structures, where the adaptive quantization selects a gain value from a plurality of gain values; and a transmission block 430 for transmitting the multiple, quantized data structures using borehole telemetry, where the multiple, quantized data structures include an indicator for the selected gain value.

As shown, the method 400 can optionally include a control block 440 for controlling drilling of the borehole based at least in part on the NMR data in the multiple, quantized data structures. For example, the NMR unit can be part of a drillstring that can be utilized to drill the borehole in the formation. In such an example, drilling may be controlled based at least in part on NMR data that represent characteristics of a formation, which may be fluid characteristics, matrix characteristics, etc. As an example, the method 400 can allow for improved drilling where NMR data can be transmitted in an expedited manner. Such an approach may allow for a higher rate of penetration (ROP) while drilling as confidence and/or control can be improved via NMR data that can be received in a more rapid manner, optionally with greater quality compared to an approach that demands a larger bandwidth.

The method 400 of FIG. 4 is shown as including various computer-readable storage medium (CRM) blocks 411, 421, 431, and 441 that can include processor-executable instructions that can instruct a computing system, which can be a control system, to perform one or more of the actions described with respect to the method 400.

As shown in the example of FIG. 4, the system 490 can include one or more computers 492 that include one or more processors 493, memory 494 operatively coupled to at least one of the one or more processors 493, instructions 496 that can be, for example, stored in the memory 494, and one or more interfaces 495 (e.g., one or more network interfaces and/or other interfaces). As an example, the system 490 can include one or more processor-readable media that include processor-executable instructions executable by at least one of the one or more processors 493 to cause the system 490 to perform actions such as, for example, one or more actions of the method 400. As an example, the instructions 496 can include instructions of one or more of the CRM blocks 411, 421, 431, and 441. The memory 494 can be or include the one or more processor-readable media where the processor-executable instructions can be or include instructions. As an example, a processor-readable medium can be a computer-readable storage medium that is non-transitory that is not a signal and that is not a carrier wave.

As an example, the system 490 can include subsystems. For example, the system 490 can include a plurality of subsystems that may operate using equipment that is distributed where a subsystem may be referred to as being a system. For example, consider a downhole tool system and a surface system. As an example, operations of the blocks 410, 420, 430 and 440 of the method 400 may be performed using a downhole tool system. The method 400 may be implemented using, for example, a downhole system and/or a surface system, which may be a cloud-based or cloud-coupled system.

Various examples are given with reference to downhole tools such as a downhole tool that can be utilized for NMR logging, which can include logging while drilling (LWD). Various equipment, techniques, etc., may be utilized in one or more other types of systems.

NMR measurements can be utilized for determining one or more of reservoir permeability, water cut, and hydrocarbon pore volume. NMR measurements may be utilized to evaluate porosity and permeability independent of mineralogy. NMR measurements may be suitable for characterizing thinly laminated reservoirs; low-contrast, low-resistivity pay zones; and carbonates.

As an example, a LWD tool can include one or more NMR units. For example, consider the MAGNISPHERE tool (Schlumberger Limited, Houston, Texas). Such a tool can generate real-time NMR data for accurate and precise reservoir characterization, which can improve well placement for more productive hydrocarbon extraction from various wells such as, for example, extended-reach wells. NMR data can provide a better understanding of producibility in complex reservoirs. NMR data can deliver lithology-independent porosity, irreducible and producible fluid volumes, pore size distribution, and continuous permeability in various reservoirs. NMR data may be utilized to identify optimal location to perforate a section to produce desirable fluids (e.g., more oil with less water). As an example, NMR data can be utilized in reservoir modeling to generate more accurate models, which may be utilized, for example, by a reservoir or other type of simulator to generate simulation results.

As an example, a NMR tool can be utilized for real-time NMR data acquisition while drilling to provide T1 and T2 relaxation times and distributions thereof, which can be indicative of the time it takes for formation fluid hydrogen nuclei to polarize and relax after being stimulated with a combination of magnetic fields. Such an approach allows for characterization of heavy and light fluids. A T2 distribution can give a better definition of fast-relaxing fluids and can provide characteristics such as microporosity and heavy oil. A T2 distribution has a faster acquisition time compared to a T1 distribution where a faster acquisition time can allow for better data statistics and precision. A T1 distribution can help characterize slower-relaxing fluids, which can characterize large pores, macroporosity, light oil, and gas. Although T1 is a longer measurement and can be sensitive to rate of penetration (ROP) while drilling, T1 has a better tolerance to lateral motion than T2. As a T2 distribution can have accuracy on one type of fluid and specific bore size, and T1 distribution on a different type of fluid and pore size, a tool that can provide both simultaneously enables characterization of a wide range of fluid types in a broader range of rock fabric.

As to powering a tool, one or more sources of power may be utilized. For example, consider battery power, wired power, downhole generated power (e.g., from a mud-lubricated turbine, etc.), etc. Power can be provided to various circuits, which can include circuitry for purposes of emitting energy, circuitry for purposes of receiving energy and circuitry for processing received energy to digital data. Power can also be provided to circuitry that can process digital data for transmission, which can be via one or more transmission technologies. For example, consider transmission to another downhole tool (e.g., another portion of a drillstring) and/or transmission to surface equipment.

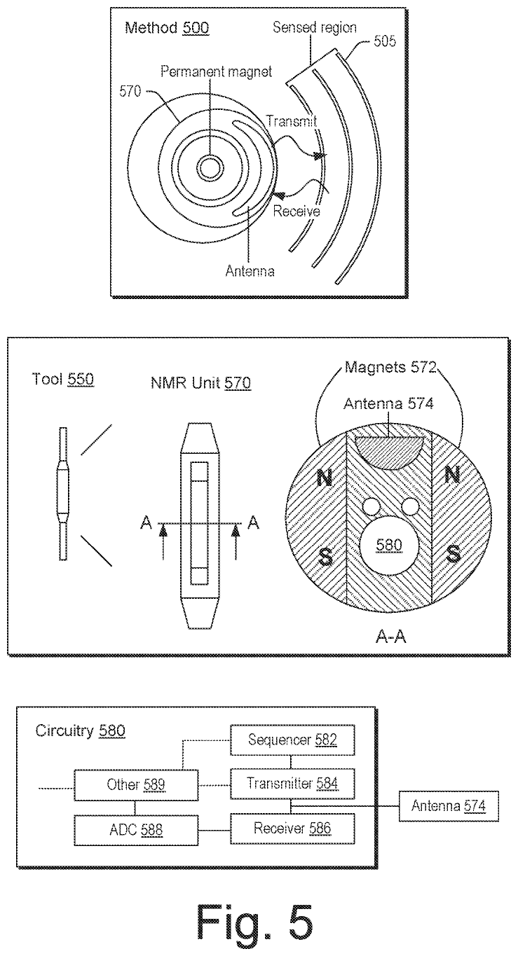

FIG. 5 shows an example of a method 500 with respect to an NMR unit 570 and a sensed region 505 where the method 500 includes exposing the sensed region 505 to a static magnetic field of permanent magnet (or magnets) of the NMR unit 570, utilizing an antenna (e.g., or other transmitter) to generate an oscillating field that penetrates the sensed region 505, and utilizing the antenna (e.g., as a receiver) to receive energy released by nuclei in the sensed region 505. As shown, one or more components can be eccentric such that the NMR unit 570 can have an orientation with respect to the sensed region 505, which can be a portion of a wall of a borehole (e.g., an uncased portion of a borehole). During drilling, when at least a portion of a drillstring is rotating and the NMR unit 570 is part of the rotating portion of the drillstring, the NMR unit 570 can be rotating too. For example, the NMR unit 570 can be rotating such that it senses information for 360 degrees of a borehole (e.g., consider the sensed region 505 as being 360 degrees and surrounding the NMR unit 570). In some instances, a drillstring may be oscillated a number of degrees in one direction and a number of degrees in another direction. In such instances, an NMR unit may capture signals during rotation in either or both directions.

FIG. 5 also shows an example of a tool 550, which can be part of a drillstring that may include one or more features such as a stabilizer, a pad or pads, a turbine, etc. As explained, a mud-lubricated turbine may respond to flow of mud (e.g., drilling fluid) to generate power locally, which can be utilized to power circuitry of the tool 550, including the NMR unit 570.

In FIG. 5, the NMR unit 570 is shown in an approximate side view and in an approximate cross-sectional view along a line A-A. In the cross-sectional view, the NMR unit 570 is shown to include magnets 572, an antenna 574 and circuitry 580, which can include RF emission circuitry, antenna circuitry and analog-to-digital conversion circuity (e.g., an analog-to-digital converter (ADC)). As an example, the NMR unit 570 can include one or more passages for one or more conduits. For example, consider a power conduit, a data transmission conduit, a power and data conduit, etc. As an example, the tool 550 can include a power source or be operatively coupled to a power source, which may be a fluid driven turbine (e.g., mud turbo-generator, etc.), a surface power source, etc. As an example, a power source may be a power grid, a generator (e.g., gas, wind, fuel, etc.), a solar panel, a battery, etc.

As to the circuitry 580, it can include one or more processors and memory accessible to at least one of the one or more processors. For example, the circuitry 580 can include a processor that executes instructions that control energy emissions to generate an oscillating magnetic field, as may be according to a programmed pulse sequence. As an example, the circuitry 580 can include one or more switches, which may be operatively coupled to sources of energy, which can include a source to generate pulsed emissions and/or a source that is an antenna or antennas that receive signals from nuclei in a formation. For example, a switch may act to control an antenna to use the antenna for transmission of energy and then to use the antenna for reception of energy. Received energy can be directed to an analog-to-digital converter that can convert analog signals to digital data according to a selected sampling rate and/or bit depth. As an example, the digital data can be stored to memory and optionally processed by the processor (e.g., downhole) and/or transmitted to another processor, storage device, etc., which may be uphole or part of the downhole tool or another downhole tool. As an example, a processor or processors can be configured using executable instructions to perform one or more operations on data such as, for example, inversion to derive one or more values (e.g., T2 values, T1 values, etc.).

As shown in the example of FIG. 5, the circuitry 580 can include a sequencer 582, a transmitter 584, a receiver 586, and an ADC 588. The sequencer 582 can include instructions or otherwise be instructed to control the transmitter 584, which can be operatively coupled to the antenna 574 for transmission of oscillating magnetic fields. The receiver 586 can be operatively coupled to the antenna 574 for reception of echo signals where such signals can be in analog form and converted into digital echo data using the ADC 588. As shown in the example of FIG. 5, other circuitry 589 can be included, which may be operatively coupled to one or more data and/or power lines. For example, consider one or more data and/or power lines operatively coupled to an uphole (e.g., surface) unit or system. As an example, the sequencer 582 may be programmable via instructions, commands, etc., received from memory locally, from a surface unit or system, another component of a downhole string, etc. As an example, a method can include controlling emissions, which may be via RF emission circuitry. As an example, such circuitry can include the sequencer 582 and the transmitter 584 as operatively coupled to the antenna 574. As an example, a method can include acquiring digital echo data, which may be via antenna circuitry and analog-to-digital conversion circuitry. As an example, such circuitry can include the antenna 574, the receiver 586 and the ADC 588. As an example, compression circuitry may be included to compress digital echo data (e.g., consider one or more of window summing, singular value decomposition, etc.). Data compression may reduce data density for transmission of data uphole to a surface unit or system (e.g., via the circuitry 589, etc.).

As an example, the tool 550 can be dimensioned for receipt in a borehole with a diameter of approximately 10 cm or more. As an example, the tool 550 can be of a maximum diameter of a tool body of approximately 5 cm or more. For example, consider an outer tool body diameter of approximately 12 cm at an NMR unit (e.g., an NMR unit with a 12 cm cross-sectional dimension).

As an example, an NMR unit may be sensitive to a volume of approximately 1 cm to approximately 3 cm or more into a formation where the volume may extend a length of an antenna along a longitudinal axis of the NMR unit (e.g., 5 cm to 15 cm or more), which can be a factor in vertical resolution. As an example, an antenna can be operated as a transmitter, a receiver or both a transmitter and a receiver. As a transmitter, an antenna can transmit a sequence for an oscillating magnetic field (e.g., consider a CPMG pulse sequence, etc.). As a receiver, an antenna can receive pulse echoes from a formation, including substances in the formation such as one or more fluids.

NMR logging can face various challenges such as one or more of the three challenges described below. First, it tends to be slow due to real world physics, specifically, the prolonged time to polarize hydrogen atoms in a static magnetic field; second, it tends to have poor SNR owing to the intrinsically weak coupling between nuclear spins and the instrument detectors; and third, an NMR logging program tends to demand substantial job planning, demanding local knowledge and domain resources and resulting in a lengthy operational workflow. Methods that reduce logging time, enhance SNR, and streamline job design are generally desirable.

NMR can be used for reservoir characterization due to its capability of measuring the hydrogen nuclei in the fluids. As both water and hydrocarbons like oil and gas contain hydrogen nuclei, they can be measured and quantified by NMR tools. Furthermore, NMR measurement of sample properties, such as relaxation times (T1 and T2) and diffusion coefficients enable understanding of the dynamics of these fluids, resulting in the interpretation of their physical state (e.g., free or bound), the sizes of the pores they are confined in, the viscosity and type of hydrocarbons, and the permeability, and other properties of the rock system.

NMR relaxation such as measured by T2 has been shown to be directly proportional to the surface-to-volume ratio of a porous material. Surface relaxivity is a quantity (in units of micron/second) that defines the strength of the surface relaxation phenomenon. Because of this relationship, NMR is used in petroleum exploration to obtain estimates of porosity, pore size, bound fluids, permeability, and other rock and fluid properties (e.g., “petrophysical data”). For example, it is known that a T2 distribution is closely related to the pore size distribution. Reservoir rocks often exhibit a wide range of T2s due to the difference in pore sizes, with observed T2 from several seconds down to tens of microseconds. Signals at long T2 (e.g., greater than 100 milliseconds) tend to be from large pores and such fluids may be considered producible. For shorter T2 signals (e.g., 3 milliseconds to 50 milliseconds), the fluids are often considered to be bound by capillary force of the pores. For example, fluids in sandstone rocks with T2 below 30 ms are considered bound by capillary force and tend not to produce. Thus, a cutoff value, T2 cut (e.g., T2 cut=30 ms) can be used to calculate the bound fluid volume:

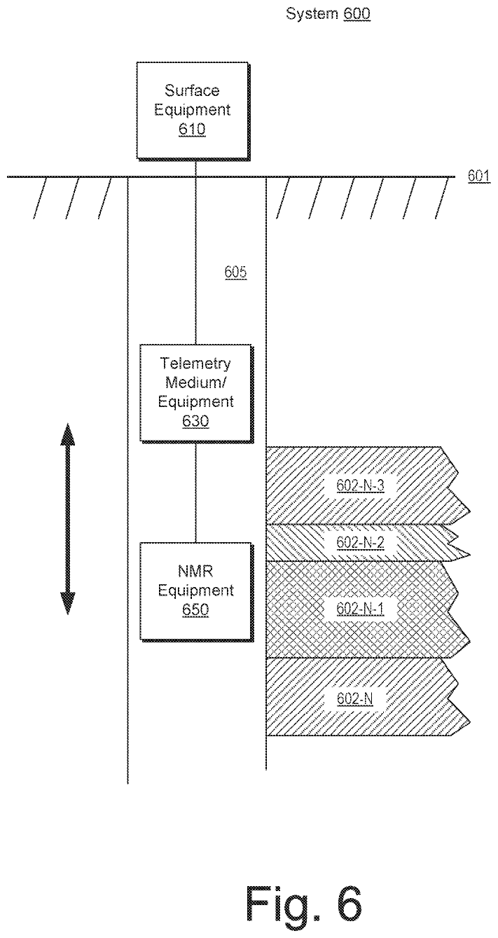

FIG. 6 shows an example of a system 600 with respect to a subsurface region that includes a surface 601, various types of formations 602-N-3, 602-N-2, 602-N-1, and 602-N, which may be referred to as formations 602 or individually as individual formations, and that includes a borehole 605 where the formations 602 define a wall of the borehole (e.g., a borehole wall). As shown in the example of FIG. 6, the formations 602 can be of different thicknesses, of different materials, and may be disposed at different angles with respect to the surface 601. As an example, the borehole 605 may be vertical or deviated. As an example, the borehole 605 may include a vertical portion and a deviated portion. As an example, in a deviated portion, the borehole 605 may traverse the formations 602 in a manner that increases path length such that the path length of the borehole 605 in each of the formations 602 is greater than the thickness of each of the formations 602.

As shown in the example of FIG. 6, the system 600 includes surface equipment 610, telemetry medium and/or equipment 630 and NMR equipment 650. As explained, whether the system 600 includes drilling equipment or logging equipment, the NMR equipment 650 can move in the borehole 605. For example, the NMR equipment 650 can be tripped in, move with drilling, tripped out, maintained at a stationary position, etc. As to movement of the NMR equipment 650, it may be referenced with respect to spatial coordinates, which may provide for a measured depth and/or a vertical depth. As an example, movement along the borehole 605 can be characterized with respect to velocity, acceleration, translation, vibration, rotation, etc.

In the example of FIG. 6, the NMR equipment 650 can be operated to acquire NMR data for the different formations 602. Where the formations 602 differ in their materials (e.g., types of materials, composition of materials, etc.), the NMR equipment 650 may operate more efficiently when an acquisition protocol is matched to one or more formation characteristics. For example, formation characteristics may result in different relaxation time constants (e.g., T1 and/or T2). In such an example, an acquisition protocol for a slow T2 (e.g., AP1) may differ from an acquisition protocol for a fast T2 (e.g., AP2). In such an example, if AP1 is applied to a non-optimal formation type (e.g., fast T2), the resulting NMR data may be of lesser quality. For example, the NMR data may be of a lower signal to noise ratio (SNR). As an example, for NMR measurements, an acquisition protocol (AP) may be characterized by a pulse sequence (PS). As an example, the NMR equipment 650 can include circuitry that can automatically change an AP, which can include changing a PS.

As an example, the system 600 can include computational resources that can automatically adjust the NMR equipment 650, which may be responsive to a formation characteristic. In such an example, the telemetry medium and/or equipment 630 may be adjusted. For example, consider an adjustment to telemetry mode, compression of data, organization of data, etc.

As an example, as the NMR equipment 650 moves in the borehole 605, the NMR equipment 650 may be adjusted in real time such that one or more adjustments are made to the NMR equipment 650 based on one or more formation characteristics of the formations 602. Such an approach may provide for more efficient operation of the NMR equipment 650, which may provide improved SNR, improved power utilization, improved telemetry, etc.

As an example, the NMR equipment 650 can automatically adjust acquisition, for example, by selecting a particular acquisition protocol (AP) from a group of acquisition protocols (APs). As an example, an automatic adjustment may include adjusting one or more parameters of an acquisition protocol (AP).

As an example, the NMR equipment 650 can include and/or be operatively coupled to a trained machine model that can receive input and generation output. In such an example, the output may be utilized to control operation of the NMR equipment 650 and/or one or more other pieces of equipment.

As mentioned with respect to FIG. 5, the NMR unit 570 (e.g., NMR equipment) can include the circuitry 580. Such circuitry may be “lightweight”. As an example, NMR equipment can include a microprocessor that has associated specifications. For example, consider a microprocessor with a relatively low clock rate (e.g., less than 100 MHz). As an example, NMR equipment can include memory that has associated specifications. For example, consider random access memory (RAM) with a relatively low amount of memory (e.g., less than 10 MB).

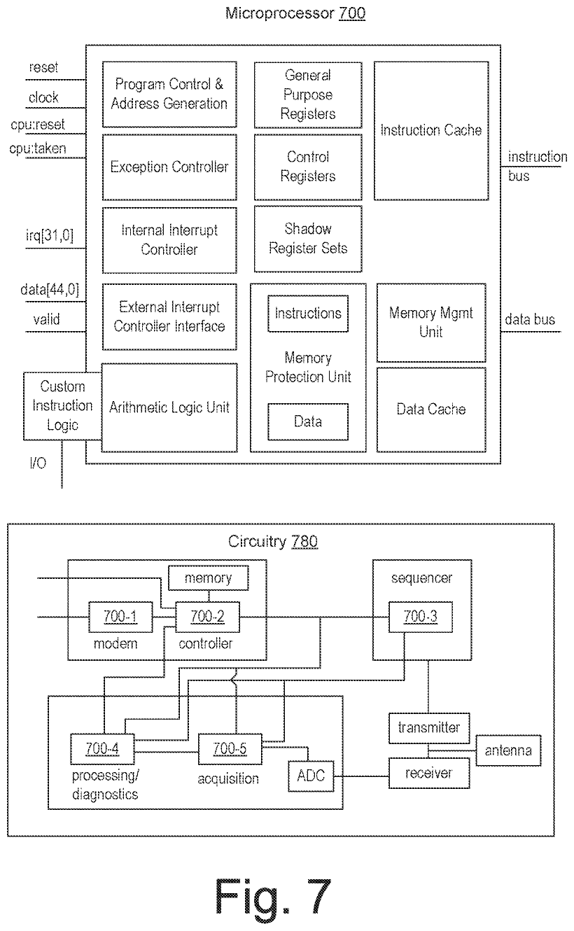

FIG. 7 shows an example of a microprocessor 700 that may be utilized in a downhole tool such as an NMR unit (e.g., NMR equipment) along with an example of circuitry 780 that can include a plurality of microprocessors 700-1, 700-2, 700-3, 700-4, and 700-5. As shown, the circuitry 780 can include a modem processor 700-1, a controller processor 700-2, a sequencer processor 700-3, a processing and diagnostics processor 700-4, and an acquisition processor 700-5. Also shown in the example circuitry 780 of FIG. 7 are memory, an ADC, a transmitter, a receiver and an antenna (see, e.g., the circuitry 580 of FIG. 5). As an example, the microprocessor 700 and/or the circuitry 780 can be utilized to perform one or more actions to compress acquired NMR data. For example, consider a compression technique that involves projecting NMR data to generate components and then applying an adaptive quantization technique to generate multiple, quantized data structures suitable for storage in memory and/or transmission via one or more telemetry systems. As an example, one or more actions of the method 400 of FIG. 4 can be performed using one or more of the features of FIG. 7.

As an example, the microprocessor 700 can include various features such as registers, cache, memory (e.g., for instructions and data), busses, a clock, address generators, interrupts, logic units, etc. As an example, the microprocessor 700 can include various features of an INTEL Corporation (Sunnyvale, California) microprocessor such as one or more of the NIOS family microprocessors (e.g., NIOS II, etc.). As an example, a microprocessor such as the microprocessor 700 may be utilized with and/or include one or more features of a device such as the CYCLONE device (Altera, San Jose, California). For example, a CYCLONE III device can include a NIOS II family microprocessor. The NIOS II family of microprocessors includes a 32-bit embedded-processor architecture designed specifically for the ALTERA family of field-programmable gate array (FPGA) integrated circuits.

A NIOS II processor can include an instruction cache, 60 MHz clock, hardware multipliers, external SRAM (for executable code and data) such as 2 MB on a modem and on a sequencer and 4 MB on a controller along with 8 MB external cache for storing FPGA image and software and a 4 GB recording cache (controller coupled). In such an example, each FPGA can possess “system on a chip” (SoC) characteristics and custom instructions to tailor functionality to the specific portion of circuity.

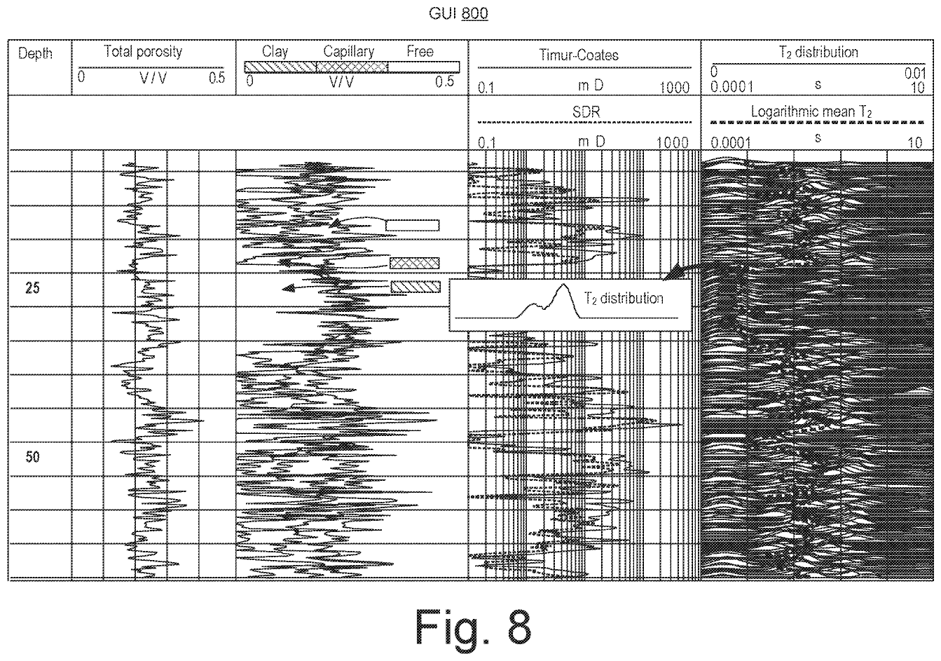

FIG. 8 shows an example of a graphical user interface (GUI) 800 that includes graphics derived from NMR data as acquired by an NMR unit of a downhole tool. The GUI 800 shows four tracks in log form, with respect to depth and various other scales. The GUI 800 may include, for example, a gamma ray track, which may help to provide indication of position (e.g., depth, measured depth, etc.). As shown, the first track includes a plot of total porosity (e.g., lithology-independent), the second track includes graphics of volumes of clay-bound water, capillary-bound water, and free fluid derived from a measured T2 distribution (see, e.g., T₂), the third track includes permeability estimate graphics as derived using Timur-Coates and Schlumberger-Doll-Research (SDR) permeability equations and the fourth track includes the measured T2 distribution as well as the logarithmic mean T2 values at various depths.

Referring again to the GUI 800 and the fourth track, T2 distributions are illustrated graphically for a series of depths. The GUI 800 shows a single T2 distribution amplified to demonstrate that T2 values can have a peak or peaks for a volume of investigation at a particular depth. As an example, a higher vertical resolution can provide for more T2 distributions over a particular segment of a borehole. As an example, a sequence that can be executed in lesser time and/or lesser data transmission demands, with acceptable data quality, can provide for a greater measurement speed, which may allow for receiving data for a segment of a borehole in a shorter period of time (e.g., more rapid formation evaluation, etc.).

As an example, a method can include various parameters such as a speed parameter, a number of NMR measurements at different depths per unit time parameter, a sequence duration parameter, a maximum speed parameter as to NMR measurements, a maximum speed parameter as to physical constraints on a logging tool and/or a logging system, a maximum data rate or bit rate for transmission of data from a downhole tool, a maximum processing rate as to processing of data (e.g., downhole and/or uphole), etc.

As explained with respect to FIG. 4, a method can provide for NMR real-time data compression in a controllable manner, which may aim to reduce bandwidth demands and/or improve transmission time. As an example, with a reduced data size, more NMR data may be stored in a downhole tool, which, in various instances, may provide for acquiring more data before pulling the downhole tool out of a borehole to surface where memory of the downhole tool may be interrogated for retrieval of the NMR data.

As an example, circuitry can be included in a tool that can implement a quantization and packaging scheme that improves performance of compression for transmission of NMR data. As explained, data may be transmitted using one or more technologies and/or techniques. A relatively low bandwidth technology is mud-pulse telemetry where pulses are generated and carried by drilling fluid (e.g., mud) to a receiver (e.g., a pressure wave receiver, etc.). Such an approach can be employed during drilling or otherwise when drilling fluid exists in an annulus between a tool and a borewall, which may be open or partially cased. As an example, a quantization and packaging scheme can be implemented in real-time during logging, whether such logging occurs during drilling or not. Where time and/or bandwidth are constraints, a quantization and packaging scheme may be implemented for transmission of NMR data.

As explained, a NMR tool can help to understand formation porosity distributions via T1 and T2 values derived from NMR spin-echo measurements, which can be measurements logged while drilling. Solving T1 and T2 distributions from NMR spin-echo measurements can be mathematically formulated as solving the following equation for ϕ:

$$E ( t ) = K ( t , T 1 , T 2 ) ϕ ( T 1 , T 2 ) , \qquad ( 1 )$$

where ϕ is the formation porosity distribution with respect to T1 and T2; K can be deemed as the kernel operation that the tool applies on the formation, which can be the magnetic polarization and tipping process over time t, expressed as:

$$K ( t , T 1 , T 2 ) = ( 1 - {e}^{( - WT / T 1 )} ) \cdot e {(}^{- t / T 2} ) ; \qquad ( 2 )$$

where E is the formation response to the tool (e.g., the spin echoes that the tool measures downhole).

In practice, ϕ can be a column vector that includes cell porosity values corresponding to selected <T1, T2>pairs. As an example, the length of the vector, nT1T2Pairs, may be selected to be ninety or another suitable length. After denoising procedures of lateral stacking and window-sum are applied, the echo variable E becomes a column vector with length of nWinSum, where each element in the vector corresponds to the mean amplitude of echoes in a relaxation time window. The value of nWinSum varies depending on the number of segments chosen for acquisition. For a configuration of six-segments, nWinSum equals seventy-five. The kernel K is a nWinSum×nT1T2Pairs matrix, whose contents are set for a given acquisition configuration and can be knowns to both downhole and uphole throughout an operation (e.g., drilling, logging, etc.).

Solving the porosity distribution variable ϕ uphole during real-time while logging tends to be challenging where a logging system is powered by mud-pulse telemetry. Where bandwidth is limited, for example, to between one to twelve bit-per-second (bps), transmission of an entire echo variable E to the surface or elsewhere becomes impractical. To provide for practical transmission scenarios, one or more compression techniques can be applied to downhole data before they are transmitted uphole or elsewhere.

As an example, one technique is singular value decomposition (SVD)-based compression. For example, an SVD-based compression technique can compress each tool scan into fifty-two bits. In such an example, the compressed bits can be packed into four DPOINTS of thirteen bits each for transmission (e.g., 52/4=13). The DPOINTS of a scan may be transmitted through a single telemetry frame, which may be a so-called Repeating Frame.

As explained, transmission can be improved through use of a quantization scheme and by foregoing various DPOINT header bits. For example, such an approach can reduce telemetry cost of a tool scan from fifty-two bits to thirty-nine bits. In various instances, the quantization scheme acts to improve data quality compared to fifty-two bit approach. Hence, transmission demands can be reduced while data quality is improved.

Where NMR data are acquired during drilling using a LWD tool, data can be noisier than for NMR data acquired during silent periods where drilling is not ongoing and/or for NMR data acquired using a wireline tool. As to compression and noise, a SVD-based compression technique may act as a low pass filter where higher order noisy components are removed.

As to tradeoffs between signal and noise, consider Shannon, C. E., A Mathematical Theory of Communication, The Bell System Technical Journal, Vol. 27, pp. 379-423, 623-656, July, October 1948, which is incorporated by reference herein. In the foregoing article, aspects of modulation such as PCM and PPM are described which exchange bandwidth for signal-to-noise ratio (SNR) along with concepts of concepts of information entropy and redundancy.

As explained, rather than transmitting a considerable amount of data of echoes, a tool can generate a NMR projection. For example, a kernel matrix can be decomposed using SVD, which is a factorization of a real or complex matrix that generalizes the eigendecomposition of a square normal matrix with an orthonormal eigenbasis to an m×n matrix. Eq. 3, below, shows an example of a SVD-based approach:

$$K = U \sum {V}^{T} , \qquad ( 3 )$$

where U and V are both unitary matrices containing the left and right singular vectors, respectively, and Σ is a rectangular diagonal matrix with non-negative decreasing singular values on the diagonal line. Eq. 1 can be re-written as

$$E = ( U \sum {V}^{T} ) ϕ \qquad ( 4 )$$

Projecting E onto the left-singular vectors U gives

$$P = {U}^{T} E \qquad ( 5 )$$

The vector P is called projection, and Eq. 4 then can be written as

$$P = ( \sum {V}^{T} ) ϕ \qquad ( 6 )$$

where, if P is transmitted uphole during real-time, the distribution vector ϕ can be solved.

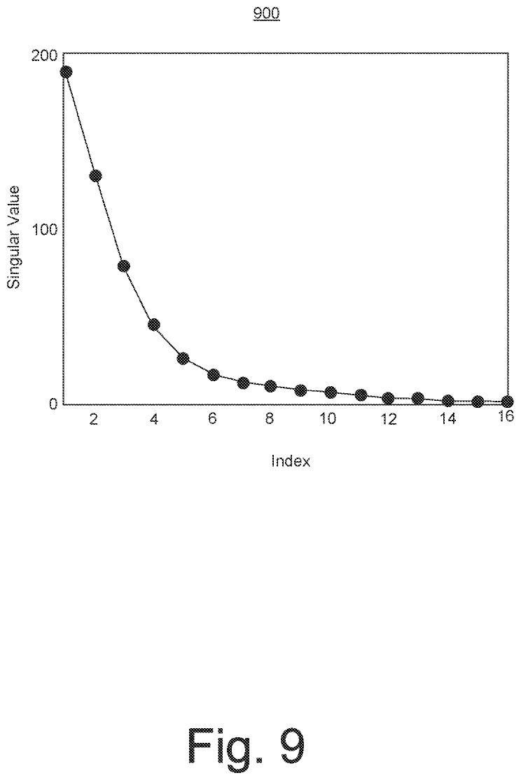

FIG. 9 shows an example plot 900 of singular value versus index. As shown, singular values in Σ decline rapidly as matrix index increases, the magnitudes of the projection components in P also decline quickly. Hence, it is possible to transmit a compressed version of P containing a few major components that are sufficient to solve ϕ in real-time at a much lower telemetry cost. For compression purpose, a SVD-based approach can truncate the kernel K into a rank-eight matrix, meaning that eight singular values, eight columns of U and V each, and eight elements of P are kept for real-time computation of the distribution vector ϕ.

Given the generation of projection components, which may be via one or more techniques (e.g., SVD-based, PCA-based, etc.), the projection components can quantized and encoded into a bit array and packed into data structures (e.g., DPOINTS) for real-time transmission. For example, let

$$W = V \sum = [ \begin{matrix}{w}_{1} & {w}_{2} & … & {w}_{8}\end{matrix} ] , {w}_{i} ∈ {ℝ}^{nT 1 T 2 Pairs} \qquad ( 7 )$$

$$ϕ = {[ \begin{matrix}{ϕ}_{1} & {ϕ}_{2} & … & {ϕ}_{nT 1 T 2 Pairs}\end{matrix} ]}^{T}$$

$$φ = {\sum }_{i = 1}^{nT 1 T 2 Pairs} {ϕ}_{i}$$

$$P = {[ \begin{matrix}{P}_{1} & {P}_{2} & … & {P}_{8}\end{matrix} ]}^{T}$$

In Eq. 7, the superscript “T” denotes “transpose”. Direct quantization of projection component Pᵢ's would be costly because of their undetermined dynamic data ranges that are associated with the porosity distribution vector ϕ. However, as ϕᵢs' are non-negative and their sum φ≤1, it can be proven that each projection component Pᵢ satisfies:

$${P}_{i} / φ ∈ [ {w}_{i , min} , {w}_{i , max} ] , \qquad ( 8 )$$

where w_{i,min} and w_{i,max} are the minimum and the maximum of the column vector wᵢ.

Quantization becomes much more manageable when it is applied to the scaled projection components of Pᵢ/φ. The scaling factor φ can be obtained, for example, by a linear-estimation method at the compression end downhole.

Each projection component Pᵢ can be quantized into an Nᵢ-bit whole number Qᵢ by the following:

$${Q}_{i} = round [ \frac{{2}^{{N}_{i}} - 1}{{w}_{i , max} - {w}_{i , min}} ( {P}_{i} / φ - {w}_{i , min} ) ] , \qquad ( 9 )$$

where the round(x) operator rounds x into the nearest whole number. The quantization resolution given by Eq. 9 is

$$Δ {P}_{i} = φ ( {w}_{i , max} - {w}_{i , min} ) / ( {2}^{{N}_{i}} - 1 ) \qquad ( 10 )$$

Quantities of Qᵢs' and φ are to be transmitted uphole to a decompression end (e.g., a decompression system). The bit allocations (N₁ to N₈) for the corresponding projection components can be 6, 6, 5, 5, 4, 4, 3, and 3, respectively; noting that one or more other bit allocations may be utilized where, for example, a first component have more bits than a last component. The factor φ can be quantized with seven bits. Bits resulting from quantization can be packaged into four 13-bit DPOINTS sharing a single predefined DATPID (e.g., DPOINT id) for transmission. In addition to quantization bits, each DPOINT also includes two header bits to notify the receiving end of its sequence number, i.e., which one of the four 13-bit DPOINTS. As a result, an NMR scan is compressed into 52 bits with 43 information bits for transmission; thus, the information rate is 82.7%.

As explained, a compression technique can reduce size of NMR data for purposes of transmission, storage, etc. (e.g., consider the method 400 of FIG. 4). In various instances, such a technique can reduce the bit cost per scan while the overall data quality is maintained or improved. Such a compression technique can involve quantization and can be characterized by an information rate.

With respect to quantization, the approach set forth with respect to Eq. 8 does not provide a choice of φ for quantization scaling that is optimal in bandwidth saving or in minimization of quantization error. In theory, Eq. 8 warrants Pᵢ/φ inside a known range, but practically Eq. 8 may not always hold due to environmental noise, inadequate wait time and inter-echo spacing, or instability of measurements. As such, Eq. 9 may result in considerable quantization errors from out-of-range truncation. Further, in cases where Pᵢs' do fall in very narrow ranges, they may be further scaled to achieve better quantization resolution. Transmission of φ with a cost seven bits is too many for a scaling factor.

Additionally, a two-bit header of a DPOINT can be considered a waste of bandwidth. For example, an approach may, instead of using a single DATPID for all DPOINTS, assigns a unique DATPID to each DPOINT such that a DPOINT structure does not include the two-bit header for identification. A DPOINT received at surface can be identified by its DATPID rather than its contents. To assure DPOINTS are transmitted in order, a system can be properly configured for a telemetry frame in a framebuilder where DATPID_1 is followed by DATPID_2, and by DATPID_3. A framebuilder can be part of circuitry of a downhole tool (e.g., instructions, hardware, etc.).

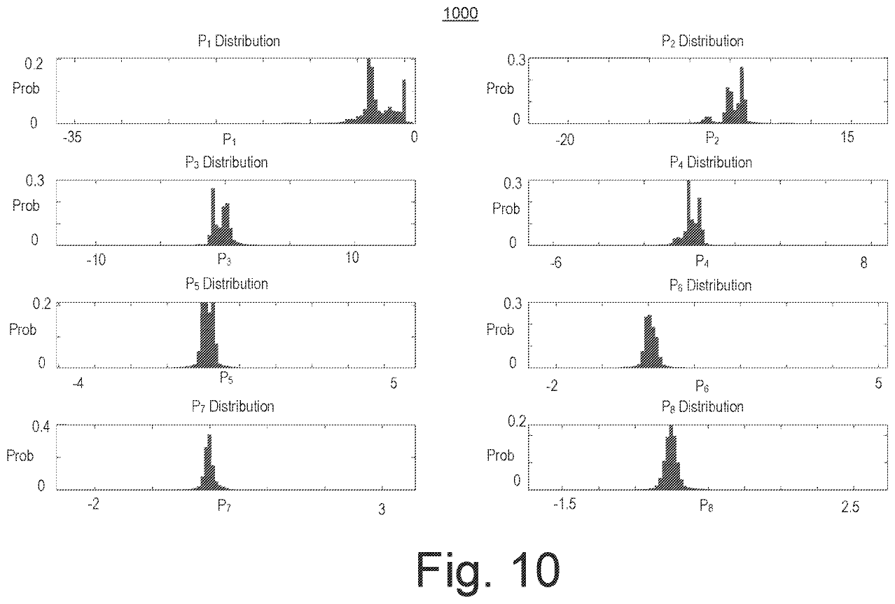

FIG. 10 shows example graphs 1000 for aspects of adaptive quantization including projection component value distributions where the x-axis in each plot represents a possible value range of a corresponding projection component and where the y-axis provides the probabilities that the component reads at the values given by the x-axis. In a real field scenario, the components tend to be distributed in a very narrow range. The graphs 1000 of FIG. 10 show statistics from six datasets, which demonstrate that the projection components tend to stay in narrow data ranges, even though the possible data range could be much wider. Such value distributions offer opportunities for adaptive quantization that can adaptively control quantization processes based on values of a projection to be compressed.

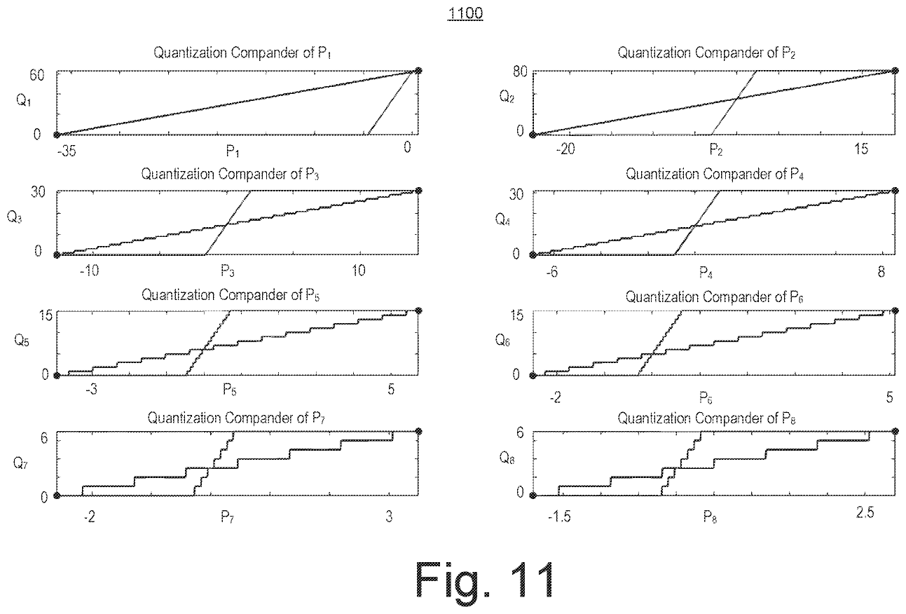

FIG. 11 shows examples of graphs 1100 for an example scenario in which the quantization compander using adaptive quantization gain control (AGC) gain factor g=8 provides a much higher quantization resolution than one using g=1 for most of the projection components following the distribution shown in FIG. 10. In the example of FIG. 11, for the projections in the six datasets, the AGC gain factor g=8 is suitable for most of the scans.

As an example, an adaptive quantization scheme can apply appropriate quantizers on the fly. For example, for each scan, an AGC can be applied to “dilate” the projection amplitudes by multiplying a scaling factor g onto the projection array before quantization, where g∈G and G=[1, 2, 4, 8, 16, 32, 64, gv]. When each the first seven options of g=1 to 64 is employed, a single g value is applied for the whole projection array. For example, when g=8, each component of P is multiplied by 8. The last option in G, which is gv (e.g., g=gv), can be utilized for one or more corner cases. For example, consider a scenario where there can be extremely high porosities, which may occur during water tank testing, where most of the components tend to present high amplitudes (e.g., closer to w_{i,min} or w_{i,max}). In the foregoing example, the quantity gv can be an eight-element gain vector such as:

$$gv = [ 2.5 , 4.25 , 6. , 3.5 , 2.5 , 3. , 3.5 , 3.5 ] , \qquad ( 11 )$$

When the option g=gv is employed, each projection component Pᵢ is shifted to the middle of its possible data range first, and then scaled by the corresponding gain factor gv(i) (e.g., or simply gain) before quantization.

As an example, a tool can include circuitry that can process acquired NMR data using adaptive quantization. For example, consider circuitry that can utilize each of the eight g options as attempted values during compression of a projection scan of NMR data. In such an example, the method can include selecting, via operation of the circuitry, one of the eight g values as a best one, denoted as ĝ, which is obtained by minimizing the distortion (e.g., mean-square error (MSE)) between the decoded, de-quantized projection components and the corresponding originals. Thus, circuitry of a tool can include performing quantization and coding and performing decoding and de-quantization in an effort to assess the performance of individual options for adaptive quantization gain control (AGC) (e.g., to determine error associated with each of the options).

As NMR data depends on the characteristics of the environment exposed to a permanent magnetic field and a radio frequency field and the release of absorbed radio frequency energy, the NMR data can differ in amplitude, phase, etc., as a tool measures different environments, whether an NMR unit is stationary while the environment changes and/or whether an NMR unit is moved or moving. As such, adaptive quantization can act to optimize compression, which, as mentioned, in some instances results in an improvement in transmitted NMR data quality while using fewer bits.

As an example, a quantization procedure can be described using the following notation:
Q: the quantized version of P
Qᵢ: the ith component of Q (the quantized version of Pᵢ)
R: the dequantized version of P (the projection array recovered from Q)
Rᵢ: the ith component of R (the de-quantized version of Pᵢ, recovered from Qᵢ)

As explained, a NMR measurement that is represented as NMR data, that are digital data, can be processed to provide a projection P that can be quantized as Q. A quantization procedure can include use of a shifting algorithm (e.g., a shift function). For example, consider function shift projection components based on statistical polarizations in a water tank where input can include:
prj: projection array of eight elements
vmin: array of minimum possible values for projections
vmax: array of maximum possible values for projections
FwdOrInv: can only be 1 or −1
1: forward shift, used in compression
1: reverse shift, used in decompression

In such an example, consider the following function:

```
function prj_shft = shiftPrj(prj, vmin, vmax, FwdOrInv)
prj_shft = prj;
iPrj2Shft = [1, 3, 4, 7, 8];
shftRatio = [0.6, 0.4, 0.4, 0.45, 0.25];
polarType = [1, 1, −1, 1, −1];
for k =1:length(iPrj2Shft)
  i = iPrj2Shft(k);
  pt = polarType(k);
  if abs(vmin(i))<abs(vmax(i))
    vSmall = vmin(i);
    vLarge = vmax(i);
  else
    vSmall = vmax(i);
    vLarge = vmin(i);
  end
  temp = prj(:, i) + FwdOrInv*pt*(vSmall-vLarge)*shftRatio(k);
  temp(temp<vmin(i))=vmin(i);
  temp(temp>vmax(i))=vmax(i);
  prj_shft(:, i) = temp;
end
```

In the foregoing function, as to polarization, consider:
−1: polarized to the end of smaller magnitude
1: polarized to the end of greater magnitude

Given the foregoing shift function, a quantization procedure can include the following:
1) Loop through step a) to e) for each g∈G=[1, 2, 4, 8, 16, 32, 64, gv],
   a) If g=gv, shift each Pᵢ of i=1, . . . , 8 to the middle of [w_{i,min}, w_{i,max}] using the shift function, skip the step otherwise.
   b) Quantize for Pᵢ into Qᵢ using Nᵢ bits for each i=1, . . . , 8:

$${Q}_{i} = round [ \frac{{2}^{{N}_{i}} - 1}{{w}_{i , max} - {w}_{i , min}} ( {gP}_{i} - {w}_{i , min} ) ] \qquad ( 12 )$$

c) Truncate Qᵢ into the range of [0, 2^{N}^{ᵢ}−1]:

$${Q}_{i} = max ( min ( {Q}_{i} , {2}^{{N}_{i}} - 1 ) , 0 ) \qquad ( 13 )$$

d) Dequantize Qᵢ into Rᵢ:

$${R}_{i} = [ {Q}_{i} ( {w}_{i , max} - {w}_{i , min} ) / ( {2}^{{N}_{i}} - 1 ) + {w}_{i , min} ] / g \qquad ( 14 )$$

e) Calculate the mean-squared error (MSE) of ∥R−P∥₂
2) Find the optimized gain factor ĝ (e.g., gain) that minimizes the MSE:

$$\hat{g} = {arg min}_{g ∋ G} {‖ R - P ‖}_{2} \qquad ( 15 )$$

3) Record the optimal ĝ and the corresponding Qᵢ for i=1, . . . , 8.

Above, the error utilized is MSE, noting that error may be formulated in one or more manners. For example, consider using an L2 error or another type of error. In various trials, MSE was utilized, which demonstrated an ability to compress NMR data and maintain or even improve data quality compared to a technique that utilizes a larger number of bits (e.g., larger bandwidth demand).

As an example, circuitry of a tool can provide for encoding, which can occur after quantization. For example, following quantization, quantized projection components along with a selected gain factor (e.g., AGC or optimized gain factor) can be encoded into a bit-stream. For example, the gain factor can be encoded into three bits as indicated below in Table 1.

TABLE 1
Example coding for gain.

| Value of ĝ | 1 | 2 | 4 | 8 | 16 | 32 | 64 | gv |
|---|---|---|---|---|---|---|---|---|
| Code | 000 | 001 | 010 | 011 | 100 | 101 | 110 | 111 |

The encoding technique for the quantized projection components Qᵢ can be a magnitude-coding scheme, which may be utilized in an approach that does not employ adaptive quantization (e.g., consider an existing compression technique). As an example, the number of bits (Nᵢ) allocated to the eight Qᵢs' can be 6, 6, 5, 5, 4, 4, 3, and 3, respectively. For example, a quantized value of Q₁=35 can be encoded into six bits as “100011”. As an example, an entire projection array can be encoded into thirty-nine bits, including three bits for the gain factor ĝ and thirty-six bits for the projection components Qᵢ of i=1 to 8.

As an example, a magnitude-coding technique, rather than an advanced entropy coding technique, may be employed to encode Qᵢ. As to statistics, a statistical analysis can show that entropy coding schemes such as Huffman coding do not reduce bandwidth effectively for an NMR data application as such.

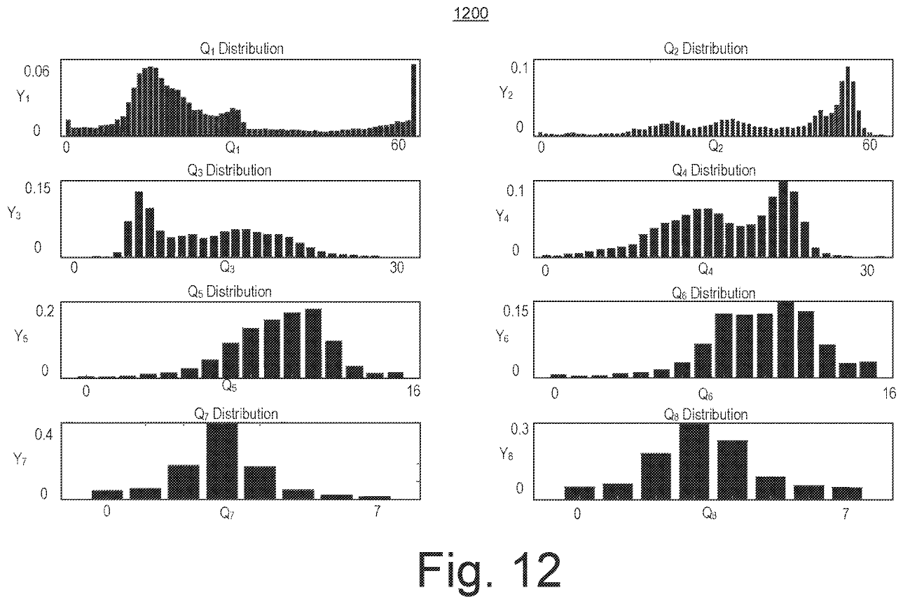

FIG. 12 shows a series of example graphs 1200 for quantized projection component (Qᵢ) and for probability distribution (Yᵢ), specifically the probability distribution of the quantized projection components. In the graphs 1200, Yᵢ(n) is the probability of Qᵢ=n, for n=0, 1, . . . , 2^{N}^{ᵢ}−1. The optimal number of bits for eight Qᵢs' combined (excluding scaling factor ĝ) given by the Shannon theorem is:

$${N}_{shannon} = - {\sum }_{i = 1}^{8} \{ {\sum }_{n = 0}^{{2}^{{N}_{i}} - 1} [ {Y}_{i} ( n ) {log}_{2} {Y}_{i} ( n ) ] \} \qquad ( 16 )$$

Based on statistics from six datasets, Nₛₕₐₙₙₒₙ≈31.2, which is 4.8 bits less than the result from an existing magnitude coding scheme (36 bits). Theoretically, the Huffman coding technique may approach the optimal number Nₛₕₐₙₙₒₙ on statistical average; however, as a variable-length coding scheme with high vulnerability to transmission errors, Huffman coding would not be a suitable choice for transmission of NMR data. The NMR data are valuable data for formation characterization, decision making, control, etc. Transmission errors for NMR data in downhole applications are to be minimized due to costs, risks, etc. Expenses and energy expenditures involved in drilling, along with associated risks to humans, equipment and borehole/formation, are too great to accept a technique that introduces a high vulnerability to transmission errors.

As explained, a data structure, referred to as a DPOINT data structure, or simply DPOINT, may be utilized as a package for transmission. As an example, circuitry of a tool can provide for packaging of NMR data and associated information into a suitable form for transmission and/or storage. As explained, transmission may utilize one or more types of transmission technologies and/or transmission techniques.

In the thirty-nine bit example of a compressed projection NMR scan, these thirty-nine bits can be packed into three thirteen-bit DPOINTS (data structures) for transmission and/or storage, as shown in Table 2, below.

TABLE 2
Bit alignment of compressed bits in three DPOINTS.

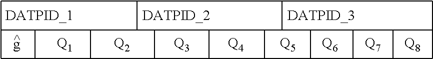

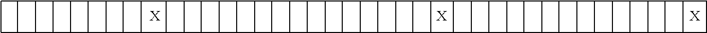

In the example of Table 2, each of the DPOINTS has an associated DATPID (e.g., DATPID_1, DATPID_2 and DATPID_3) where each of the DPOINTS is a data structure that includes a number of bits where the number of bits in each of the DPOINTS is equal to thirteen. As an example, an error code for a DPOINT can be a full scale value where each bit is equal to 1. To assure that confusion does not exist between an actual full scale value and such an error code, note that each of the DPOINTS for each of the DATPIDs includes an “x”. Where a full scale value is indicated for a component of the projection of a NMR scan, the least significant bit (LSB) of the bits for a component in each of the DPOINTs can be set to 0, rather than 1. For example, if the component Q₁ is at its full scale value [1, 1, 1, 1, 1, 1], that component will be degraded slightly by changing its LSB to 0 such that DPOINT entry for the component Q₁ is [1, 1, 1, 1, 1, 0]. As shown in Table 2, each of the DPOINTs for each of the DATPIDs can include a LSB of a smallest full component in the DPOINT with a bit that can be set to 0 to avoid confusion with an error code that uses the full scale value. As the bits for component Q₂ are not fully within the first DPOINT (e.g., the DPOINT with DATPID_1), the LSB for the component Q₁ is utilized rather than a non-LSB of the component Q₂. As shown, each data structure includes an adjustable bit to distinguish a viable measurement (e.g., a projected component) from an error code.

In the foregoing example of Table 2, a unique DATPID (namely DPOINT_1, DPOINT_2, and DPOINT_3) can be assigned to each of the three DPOINTS. The three DPOINTS (data structures) from a NMR scan can be placed in a common telemetry frame, and as close as possible. As the length of a telemetry frame may be approximately 60 seconds to approximately 180 seconds and given that a MAGNISPHERE tool NMR scan period can be from approximately 30 to approximately 60 seconds, one frame may include more compressed scans to improve depth resolution of NMR logs. For example, in a scenario of the 40-second scans transmitted by a 120-seconds telemetry frame, a tool can include three scans totally of twelve DPOINTS in the frame if associated bandwidth is available. Table 3, below, shows some examples of DATPID values and DPOINT values.

TABLE 3
Example DATPIDs and DPOINT values

| DATPID | DPOINT Values |
|---|---|
| 5001 | 1898 |
| 5002 | 2857 |
| 5003 | 5081 |
| Other IDs . . . | . . . |
| . . . | . . . |
| 5001 | 4088 |
| 5002 | 7125 |
| 5003 | 2253 |
| . . . | . . . |

As an example, a method can include transmitting each data structure using an appropriate telemetry system. For example, each DPOINT can be transmitted through a mud telemetry system (e.g., mud-pulse telemetry). As explained, a 13-bit data word can be referred to as a DPOINT, which is a data structure, where a 39-bit compression result of acquired NMR data is composed of 3 DPOINTS. An identifier, referred to as a DATPID, can be assigned to a DPOINT of a certain type of data. For example, three unique IDs can be assigned to three different DPOINTS, respectively. As an example, in a method that is executed during logging, DPOINT values can be changing as a logging tool moves in a borehole where IDs can be repeating (e.g., recycled). For example, as shown in Table 3, DATPID_1 can equal 5001, DATPID_2 can equal 5002, and DATPID_3 can equal 5003, where such values can be recycled for different scans. A telemetry system may receive data in a telemetry frame in a manner in accordance with the examples of Table 3.

As explained, in various protocols, a full-scaled value (0x1FF) of a DPOINT can be transmitted representing a downhole communication error when the telemetry tool fails to receive a requested DPOINT from a tool. Without additional coding modification, conflict would occur if the compressed value of the DPOINT was truly 0x1FF since the value after transmitted to uphole would be deemed a communication error and get trashed. Therefore, in the cases when a DPOINT value result from compression is 0x1FF, the least significant bit (LSB) of a Qᵢ in the DPOINT (as indicated by ‘x’ in above in Table 2) is flipped to 0 and the value 0x1FE is sent for 0x1FF to avoid the conflict with minimal sacrifice of data accuracy.

Compression results are presented for three datasets: two MAGNISPHERE tool field jobs and a lab test in a water tank. Compressions of the projections are performed for both the adaptive quantization approach and an existing approach as implemented using circuitry of the MAGNISPHERE tool. Comparative assessments are performed as to quality of the recovered projections from the two approaches, assuming that the scans measured by the tool are compressed and transmitted in real-time. These comparative assessments demonstrate that the adaptive quantization approach is able to maintain or improve the quality of the recovered projections from compression while saving 25% of bandwidth. In the field, where telemetry bandwidths can be insufficient to send every performed scan, the adaptive quantization approach can improve the update rate of projections by 25 percent over the existing approach under the same bandwidth consumption.

The Root of Mean-Squared Error (RMSE) can be used a metric to quantify the compressed data quality. The RMSE for the ith projection component is defined as:

$$RMSE [ i ] = \sqrt{\frac{1}{N} {\sum }_{i = 1}^{N} {( {R}_{i} [ n ] - {P}_{i} [ n ] )}^{2}} , \qquad ( 17 )$$

where Pᵢ[n] and Rᵢ[n] are the ith (i=1, . . . , 8) original and the recovered projection component of the nth scan, respectively. The total RMSE for an entire scan can be defined as:

$$RMSE\_Tot = \sqrt{\frac{1}{8 N} {\sum }_{i = 1}^{8} {\sum }_{n = 1}^{N} {( {R}_{i} [ n ] - {P}_{i} [ n ] )}^{2}} \qquad ( 18 )$$

For various trials using acquired data, a comparison of performance of the adaptive quantization approach and the existing approach for each of the trial data sets was performed. From a Job_1 data set and a Job_2 data set, graphs of the compressed projections from the adaptive quantization approach in the time domain were compared to the original projections before compression. From such comparisons, error curves were generated to demonstrate error resulting from compression. In particular, RMSE and RMSE_Tot error curves were generated. The error curves demonstrated that the adaptive quantization approach lessens the quantization noise and reduces the RMSE values by approximately 50%. The compressed projections from both approaches were further merged into the depth domain and corresponding porosity curves (NMR porosity (MRP)) computed. The actual job data demonstrated that the adaptive quantization approach could adequately represent NMR data, as projected, and reduce bandwidth and/or data storage demands while, in various instances, improving data quality compared to an existing compression technique (EC) that utilized more bits.

The trial results demonstrated a reduction of compression error. In various examples, RMSE was reduced over 50%. Further, trial results demonstrated improved fidelity of compressed data in low porosity zones. And, as explained, application of an example adaptive quantization technique reduced bandwidth demand by 25 percent compared to an existing compression technique (EC).

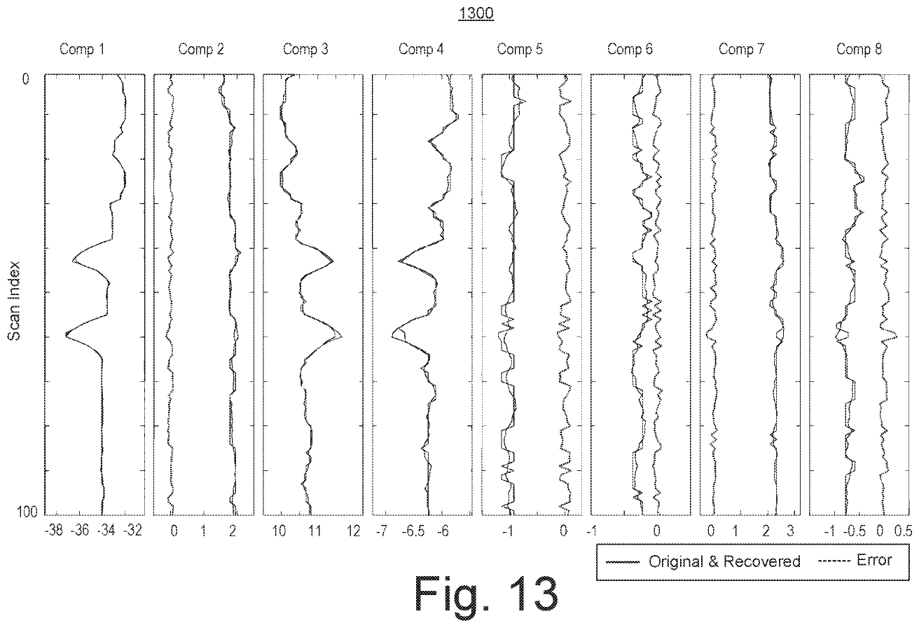

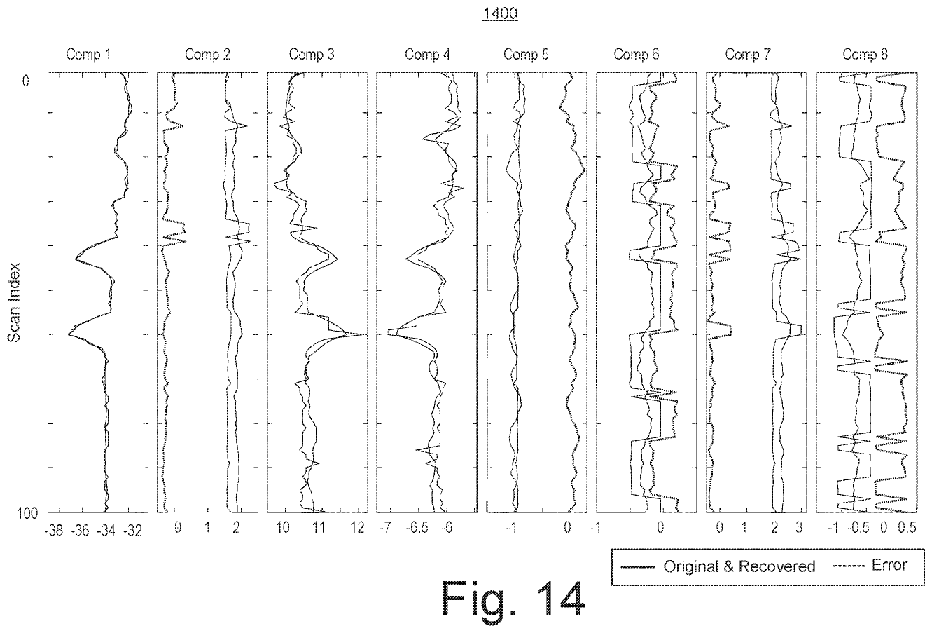

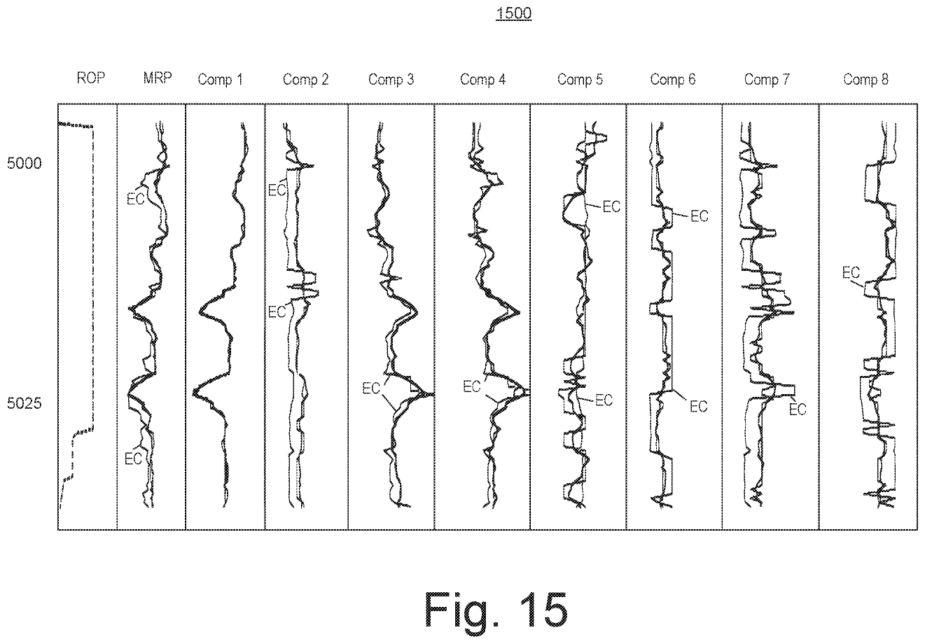

FIG. 13, FIG. 14 and FIG. 15 shows graphs 1300, 1400 and 1500, respectively, for an extreme case of a 100-pu water tank trial data set. The data in the graphs 1300, 1400 and 1500 demonstrate improvement through use of the adaptive quantization approach.

In FIG. 13, graphs 1300 include eight tracks, one track for each of eight components resulting from application of a projection technique (see, e.g., the plot 900 of FIG. 9 for an SVD technique). As explained, the number of components may be determined from an analysis that indicates how much information may be included in each component where, generally, information content drops off as the number of a component increases (e.g., a component with an index of 8 generally includes less useful information than a component with an index of 6). If a different number of components is utilized as part of a compression technique, then the graphs 1300 would include a different number of tracks.

In the graphs 1300, the original component and the recovered component for each of 100 scans is presented where error between the original component and the recovered component is indicated by a dashed line, except for components 1, 3 and 4, as the scales for those three tracks does not include zero. For the tracks that do include zero in their scales, specifically, components 2, 5, 6, 7 and 8, the error is shown to be quite close to zero, with some deviations above and below zero.

In FIG. 14, the graphs 1400 correspond to the same data sets as utilized in the graphs 1300 of FIG. 13, however, using an existing compression technique (EC), which demands a greater bandwidth than the compression technique applied in the example of FIG. 13. As with the graphs 1300, in the graphs 1400, error is shown in the tracks for components 2, 5, 6, 7 and 8, where the error can be considerably greater. In particular, a comparison of error in the tracks for components 5, 6, 7 and 8 of FIG. 13 to the error in the tracks for components 5, 6, 7 and 8 of FIG. 14 demonstrates that the approach utilized in the example of FIG. 13 is superior because less error is introduced by compression and decompression.

In FIG. 15, the graphs 1500 correspond to the aforementioned data sets as utilized in the graphs 1300 of FIG. 13 and the graphs 1400 of FIG. 14 and also include a track for rate of penetration (ROP) and a track for NMR porosity (MRP), where the ROP track indicates speed of movement of the NMR tool. In FIG. 15, each of the tracks for the components 1 to 8 includes the component from the recorded log, the recovered component from an example adaptive quantization technique and the recovered component from an existing compression technique (EC), as labeled EC. As shown, the example adaptive quantization technique outperforms the existing compression technique. Per the MRP track, the improved performance extends to improved porosity values.

As an example, an environment can be stratified where, geologically, it may be characterized via stratigraphy (see, e.g., FIG. 6). As an example, a downhole tool can be conveyed in a borehole to make sensor measurements that can help in characterization of the environment, which may include measurements that can improve characterization via stratigraphy (e.g., lithostratigraphy (lithologic stratigraphy) and/or biostratigraphy (biologic stratigraphy)).

As an example, a system can be an embedded system tool. For example, the tool can be transportable and optionally powered by its own internal power supply and/or a transportable power generator (e.g., turbine, solar, etc.). As an example, an embedded system tool can include telemetry circuitry that can communicate with another system such as a high-performance computing system (HPC system), which may be, for example, a workstation type of computing system. As an example, a system can include a downhole tool and an uphole system with more computing facility that the downhole system.

As an example, a method can include acquiring NMR data using a NMR unit disposed in a borehole in a formation, where the NMR data represent characteristics of the formation; compressing the NMR data using projection followed by adaptive quantization to generate multiple, quantized data structures, where the adaptive quantization selects a gain value from a plurality of gain values; and transmitting the multiple, quantized data structures using borehole telemetry, where the multiple, quantized data structures include an indicator for the selected gain value. In such an example, the projection can utilize singular value decomposition or, for example, another technique (e.g., PCA, etc.).

As an example, a projection can generates a number of components where each of the components is represented by a number of bits in one or more of the multiple, quantized data structures. In such an example, a first component of the number of components can be represented by a greater number of bits than a last component of the number of components. As an example, a number of components can be less than ten.

As an example, a data structure can include 13 bits or another number of bits where a number of data structures for a NMR scan can include a gain indicator in one of the number of data structures (e.g., to indicate a gain for the number of data structures). As an example, an indicator for a selected gain can include at least two bits; noting that a single bit may suffice where two gain options exist and that three bits may be utilized for eight gain options.

As an example, multiple, quantized data structures can include at least two quantized data structures where one of the at least two quantized data structures includes an indicator for a selected gain value.

As an example, a method can include compressing where such compressing includes quantizing and de-quantizing projected NMR data using each of a plurality of gain values to determine error values and, based on a lowest error value, selecting one of the gain values to generate multiple, quantized data structures. As explained, at least one of the multiple, quantized data structures can include a bit or bits that indicates a selected gain value. As an example, error values may be mean-square error (MSE) values.

As an example, a method can include selecting a gain value where the selected gain value depends at least in part on characteristics of a formation. As explained, performance of NMR can depend on various factors, including formation characteristics. An optimal gain for NMR data of one type of formation may differ from an optimal gain for NMR data for another type of formation. Where a NMR unit is moved in a borehole from one type of formation to another type of formation, selected gain values can differ, which, in itself, can be an indicator of a change. As an example, gain values may be assessed with respect to operation of equipment and/or formation characteristics. In such an example, gain values themselves can provide information. As an example, a selected gain value may depend at least in part on noise.

As an example, a method can include decompressing transmitted multiple, quantized data structures to characterize a formation. In such an example, an NMR unit can be part of a drillstring where decompressing occurs during drilling of the borehole using the drillstring. As an example, a method can include controlling a drilling based at least in part on a characterization of a formation using NMR data.

As an example, a system can include a processor; memory accessible to the processor; processor-executable instructions stored in the memory and executable by the processor to instruct the system to: acquire NMR data using a NMR unit disposed in a borehole in a formation, where the NMR data represent characteristics of the formation; compress the NMR data using projection followed by adaptive quantization to generate multiple, quantized data structures, where the adaptive quantization selects a gain value from a plurality of gain values; and transmit the multiple, quantized data structures using borehole telemetry, where the multiple, quantized data structures include an indicator for the selected gain value. In such an example, the system may include the NMR unit. As an example, a system may include a telemetry unit to transmit multiple, quantized data structures (e.g., to surface, to another tool, etc.).

As an example, one or more computer-readable storage media can include processor-executable instructions executable to instruct a processor to: acquire NMR data using a NMR unit disposed in a borehole in a formation, where the NMR data represent characteristics of the formation; compress the NMR data using projection followed by adaptive quantization to generate multiple, quantized data structures, where the adaptive quantization selects a gain value from a plurality of gain values; and transmit the multiple, quantized data structures using borehole telemetry, where the multiple, quantized data structures include an indicator for the selected gain value. In such an example, the projection can generate a number of components where each of the components is represented by a number of bits in one or more of the multiple, quantized data structures.

As an example, one or more computer-readable storage media can include instructions to compress that include instructions to quantize and de-quantize projected NMR data using each of a plurality of gain values to determine error values and, based on a lowest error value, select one of the gain values to generate multiple, quantized data structures.

As an example, one or more computer-readable storage media can include processor-executable instructions to instruct a computing system to perform one or more methods. In such an example, the one or more computer-readable storage media can be a program product (e.g., a computer program product, a computer system program product, etc.).

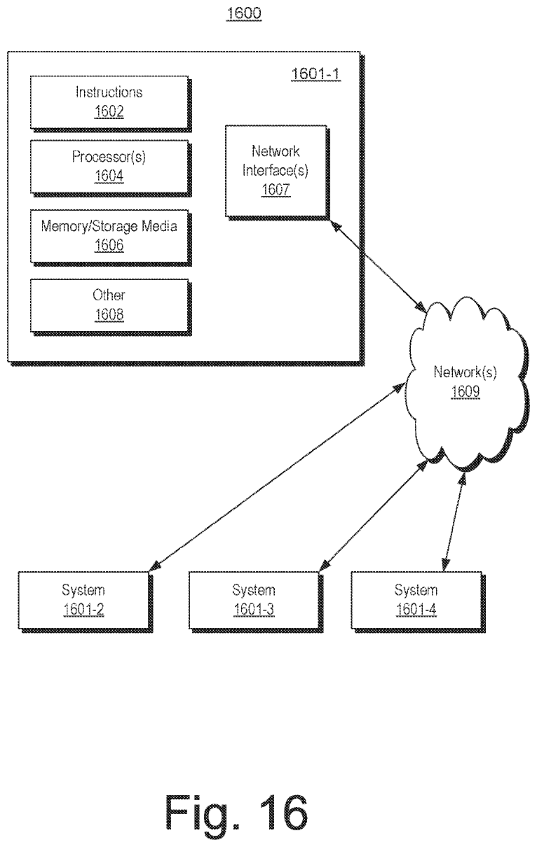

In some embodiments, a method or methods may be executed by a computing system. FIG. 16 shows an example of a system 1600 that can include one or more computing systems 1601-1, 1601-2, 1601-3 and 1601-4, which may be operatively coupled via one or more networks 1609, which may include wired and/or wireless networks.

As an example, a system can include an individual computer system or an arrangement of distributed computer systems. In the example of FIG. 16, the computer system 1601-1 can include one or more sets of instructions 1602, which may be or include processor-executable instructions, for example, executable to perform various tasks (e.g., receiving information, requesting information, processing information, simulation, outputting information, etc.).

As an example, a set of instructions may be executed independently, or in coordination with, one or more processors 1604, which is (or are) operatively coupled to one or more storage media 1606 (e.g., via wire, wirelessly, etc.). As an example, one or more of the one or more processors 1604 can be operatively coupled to at least one of one or more network interface 1607. In such an example, the computer system 1601-1 can transmit and/or receive information, for example, via the one or more networks 1609 (e.g., consider one or more of the Internet, a private network, a cellular network, a satellite network, etc.). As shown, one or more other components 1608 can be included.

As an example, the computer system 1601-1 may receive from and/or transmit information to one or more other devices, which may be or include, for example, one or more of the computer systems 1601-2, etc. A device may be located in a physical location that differs from that of the computer system 1601-1. As an example, a location may be, for example, a processing facility location, a data center location (e.g., server farm, etc.), a rig location, a wellsite location, a downhole location, etc.

As an example, a processor may be or include a microprocessor, microcontroller, processor component or subsystem, programmable integrated circuit, programmable gate array, or another control or computing device.

As an example, the storage media 1606 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICS, FPGAs, PLDs, or other appropriate devices.

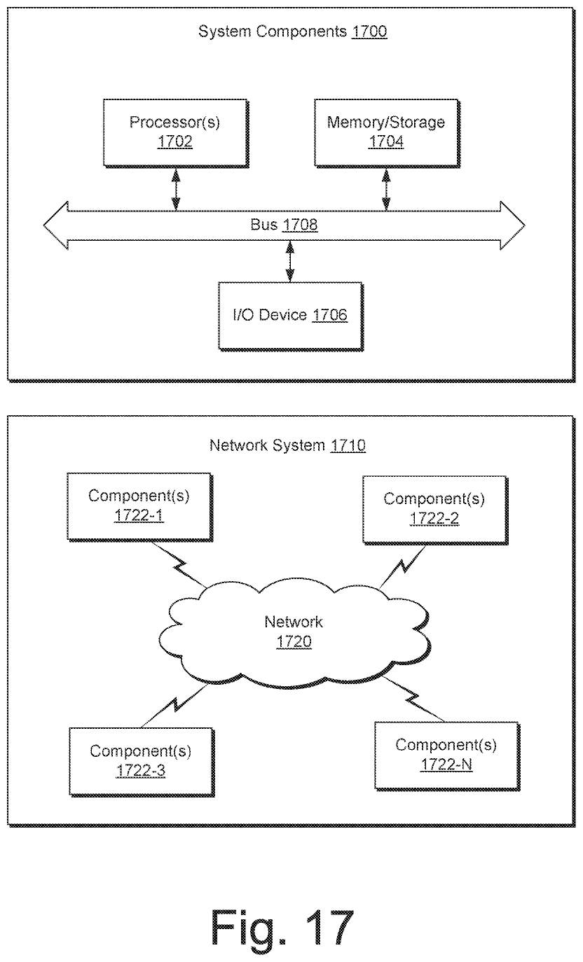

FIG. 17 shows components of a computing system 1700 and a networked system 1710, along with a network 1720. The system 1700 includes one or more processors 1702, memory and/or storage components 1704, one or more input and/or output devices 1706 and a bus 1708. According to an embodiment, instructions may be stored in one or more computer-readable media (e.g., memory/storage components 1704). Such instructions may be read by one or more processors (e.g., the processor(s) 1702) via a communication bus (e.g., the bus 1708), which may be wired or wireless. The one or more processors may execute such instructions to implement (wholly or in part) one or more attributes (e.g., as part of a method). A user may view output from and interact with a process via an I/O device (e.g., the device 1706). According to an embodiment, a computer-readable medium may be a storage component such as a physical memory storage device, for example, a chip, a chip on a package, a memory card, etc.

According to an embodiment, components may be distributed, such as in the network system 1710. The network system 1710 includes components 1722-1, 1722-2, 1722-3, . . . 1722-N. For example, the components 1722-1 may include the processor(s) 1702 while the component(s) 1722-3 may include memory accessible by the processor(s) 1702. Further, the component(s) 1722-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
acquiring NMR data using a NMR unit disposed in a borehole in a formation, wherein the NMR data represent characteristics of the formation;
compressing the NMR data using projection followed by adaptive quantization to generate multiple, quantized data structures, wherein the adaptive quantization selects a gain value from a plurality of gain values; and
transmitting the multiple, quantized data structures using borehole telemetry, wherein the multiple, quantized data structures comprise an indicator for the selected gain value.

2. The method of claim 1, wherein the projection comprises singular value decomposition.

3. The method of claim 1, wherein the projection generates a number of components and wherein each of the components is represented by a number of bits in one or more of the multiple, quantized data structures.

4. The method of claim 3, wherein a first component of the number of components is represented by a greater number of bits than a last component of the number of components.

5. The method of claim 3, wherein the number of components is less than ten.

6. The method of claim 1, wherein the indicator for the selected gain value comprises at least two bits.

7. The method of claim 1, wherein one of the multiple, quantized data structures comprises the indicator for the selected gain value.

8. The method of claim 1, wherein compressing comprises quantizing and de-quantizing projected NMR data using each of the plurality of gain values to determine error values and, based on a lowest error value, selecting one of the gain values to generate the multiple, quantized data structures.

9. The method of claim 8, wherein the error values are mean-square error values.

10. The method of claim 1, wherein the selected gain value depends at least in part on characteristics of the formation.

11. The method of claim 1, wherein the selected gain value depends at least in part on noise.

12. The method of claim 1, further comprising decompressing the transmitted multiple, quantized data structures to characterize the formation.

13. The method of claim 12, wherein the NMR unit is part of a drillstring and wherein the decompressing occurs during drilling of the borehole using the drillstring.

14. The method of claim 13, further comprising controlling the drilling based at least in part on a characterization of the formation.

15. A system comprising:
a processor;
memory accessible to the processor;
processor-executable instructions stored in the memory and executable by the processor to instruct the system to:
acquire NMR data using a NMR unit disposed in a borehole in a formation, wherein the NMR data represent characteristics of the formation;
compress the NMR data using projection followed by adaptive quantization to generate multiple, quantized data structures, wherein the adaptive quantization selects a gain value from a plurality of gain values; and
transmit the multiple, quantized data structures using borehole telemetry, wherein the multiple, quantized data structures comprise an indicator for the selected gain value.

16. The system of claim 15, further comprising the NMR unit.

17. The system of claim 15, further comprising a telemetry unit to transmit the multiple, quantized data structures.

18. One or more computer-readable storage media comprising processor-executable instructions executable to instruct a processor to:
acquire NMR data using a NMR unit disposed in a borehole in a formation, wherein the NMR data represent characteristics of the formation;
compress the NMR data using projection followed by adaptive quantization to generate multiple, quantized data structures, wherein the adaptive quantization selects a gain value from a plurality of gain values; and
transmit the multiple, quantized data structures using borehole telemetry, wherein the multiple, quantized data structures comprise an indicator for the selected gain value.

19. The one or more computer-readable storage media of claim 18, wherein the projection generates a number of components and wherein each of the components is represented by a number of bits in one or more of the multiple, quantized data structures.

20. The one or more computer-readable storage media of claim 18, wherein the instructions to compress comprise instructions to quantize and de-quantize projected NMR data using each of the plurality of gain values to determine error values and, based on a lowest error value, select one of the gain values to generate the multiple, quantized data structures.
